(19) United States
(12) Patent Application Publication
(10) Pub. No.: US 2011/0014492 A1
(43) Pub. Date: Jan. 20, 2011

(54) METHOD AND DISPERSION FOR APPLYING A METAL LAYER TO A SUBSTRATE AND METALLIZABLE THERMOPLASTIC MOLDING COMPOUND

(75) Inventors: Ketan Joshi, Mannheim (DE); Stephan Hermes, Bad Durkheim (DE); Norbert Wagner, Mutterstadt (DE); Christoffer Kieburg, Maxdorf (DE)

Correspondence Address: CONNOLLY BOVE LODGE & HUTZ LLP, P.O. BOX 2207, WILMINGTON, DE, 19899, US

(73) Assignee: BASF SE

(21) Appl. No.: 12/922,421

(22) PCT Filed: Mar. 13, 2009
(86) PCT No.: PCT/EP09/52990

§ 371 Date: Sep. 13, 2010

(30) Foreign Application Priority Data
Mar. 13, 2008 (EP) 08152712.9

(51) Int. Cl. B32B 15/08; B05D 3/02; B32B 15/04; H01B 1/20; H01B 1/22; C23C 28/00; C25D 5/54; C25D 5/56; B05D 3/00; B05D 3/12

(52) U.S. Cl. 428/626; 427/383.1; 428/457; 252/511; 252/503; 205/183; 205/205; 205/261; 205/238; 205/164; 427/299; 427/322; 264/129

(57) ABSTRACT

The process for the application of a metal layer on a substrate by deposition of a metal from a metal salt solution comprises the presence of exfoliated graphite in the substrate surface.

The present invention relates to processes and dispersions for the application of a metal layer on a substrate by deposition of a metal from a metal salt solution, and also to the use of exfoliated graphite for the application of a metal layer on a substrate, and also to metallizable thermoplastic molding compositions.

There are known processes for metallizing non-electrically-conductive materials, such as plastics. These metallized parts, for example metallized plastics parts, are used in a wide variety of application sectors, and by way of example their electrical conductivity permits their use as electrical components. They are moreover widely used inter alia in the decorative sector, since they have the same appearance as articles manufactured entirely from metal, with advantages due to lower weight and lower-cost production.

A known method for providing plastics with electrical conductivity (a necessary precondition of metal deposition by an electroplating method) is the incorporation of carbon nanotubes—or carbon nanofibrilles—into plastic or into coating dispersions. Other advantages of these electrically conductive carbon nanotubes are that they weigh less than, for example, metal powders and that they usually increase the toughness of plastics. Suitable processes, thermoplastic molding compositions, or dispersions are described by way of example in WO 2008/015169, WO 2008/015167, and WO 2008/015168.

It is an object of the present invention to provide improved processes for the application of a metal layer on a substrate by deposition of a metal from a metal salt solution by a chemical and/or electroplating method. A particular intention was to provide processes which can deposit metal layers on a substrate with good adhesion to the substrate within comparatively short electroplating times at low cost and with good quality, and where the metallized substrates have comparatively low weight.

Another object of the present invention is to provide metallizable moldings composed of plastic which, when compared with known metallizable moldings, have good mechanical properties, in particular good toughness and formability, and also good processing properties, for example in forming processes for the production of complex-shape components, and which can be metallized without complicated pretreatment of the plastics surface, and which moreover have an improved combination of properties composed of low weight and of high electrical surface conductivity.

Another object of the present invention is to provide optimized systems for the homogeneous and continuous metallic coating of non-electrically-conducting substrates, in particular by using conductive lacquers or conductive dispersions, which when compared with known systems have an improved combination of properties composed of low weight, and good adhesion, dispersibility, and flowability, and high electrical conductivity, and which can also be metallized rapidly.

Another object of the invention is to provide an alternative process which can produce electrically conductive, structured or non-structured surfaces on a backing, these surfaces being homogeneous and continuously electrically conductive.

Accordingly, the processes mentioned in the introduction have been found for the application of a metal layer on a substrate by deposition of a metal from a metal salt solution by a chemical and/or electroplating method, an essential factor in these being that the substrate surface comprises exfoliated graphite.

The use of exfoliated graphite has moreover been found for the application of a metal layer on a substrate.

The processes of the invention permit improved application of a metal layer on a substrate by depositing a metal salt from a metal salt solution by a chemical and/or electroplating method. More particularly, the processes of the invention can deposit metal layers on a substrate with good adhesion to the substrate within comparatively short electroplating times, at low cost and with good quality. The resultant metallized substrates have comparatively low weight.

The thermoplastic molding compositions have moreover been found for the production of moldings that can be metallized by a currentless and/or electroplating method, comprising, based on the total weight of components A, B, C, D, and E, which gives a total of 100% by weight,
a from 20 to 98% by weight of a thermoplastic polymer as component A,
b from 1 to 30% by weight of exfoliated graphite as component B,
c from 1 to 70% by weight of electrically conductive particles whose average particle diameter is from 0.01 to 100 μm as component C,
d from 0 to 10% by weight of a dispersing agent as component D, and
e from 0 to 40% by weight of fibrous or particulate fillers, or a mixture of these, as component E.

The invention also provides processes for the production of moldings metallized by a currentless and/or electroplating method, and the use of metallized moldings, and also provides electrically conducting components, EMI shielding units, e.g. absorbers, attenuators, or reflectors for electromagnetic radiation, and gas barriers, and decorative parts comprising these articles.

The inventive thermoplastic molding compositions are of substantial importance for provision of metallizable moldings composed of plastic which contrast with known metallizable moldings in having good mechanical properties, in particular good toughness and formability, and also good processing properties, for example in forming processes for the production of complex-shape components, and which can be metallized without pretreatment of the plastics surface and which moreover have an improved combination of properties composed of low weight and of high electrical surface conductivity.

These inventive thermoplastic molding compositions for production of moldings which can be metallized by a currentless and/or electroplating method, comprise, based on the total weight of components A, B, C, D, and E, which gives a total of 100% by weight,

a from 20 to 98% by weight, preferably from 38 to 88% by weight, particularly preferably from 46 to 70% by weight, of component A,

b from 1 to 30% by weight, preferably from 2 to 25% by weight, particularly preferably from 4 to 20% by weight, of component B,

c from 1 to 70% by weight, preferably from 10 to 60% by weight, particularly preferably from 20 to 50% by weight, of component C,

d from 0 to 10% by weight, preferably from 0 to 8% by weight, particularly preferably from 0 to 5% by weight, of component D, and

e from 0 to 40% by weight, preferably from 0 to 30% by weight, particularly preferably from 0 to 10% by weight, of component E.

A dispersion for the application of a metal layer on a non-electrically-conductive substrate has also been found, comprising

a from 0.1 to 99.8% by weight, based on the total weight of components A, B, C, and D, of an organic binder component A;

b from 0.1 to 30% by weight, based on the total weight of components A, B, C, and D, of exfoliated graphite as component B;

c from 0.1 to 70% by weight, based on the total weight of components A, B, C, and D, of electrically conductive particles whose average particle diameter is from 0.01 to 100 μm as component C;

d from 0 to 99.7% by weight, based on the total weight of components A, B, C, and D, of a solvent component D.

Processes for the production of this dispersion have also been found, as have the use of this dispersion, processes for the production of a metal layer on the surface of a non-electrically-conductive substrate, and substrate surfaces, and also the use of these.

The dispersions of the invention are of substantial importance for the provision of optimized systems for the metallic coating of non-electrically-conducting substrates, in particular by using conductive lacquers or conductive dispersions which when compared with known systems have an improved combination of properties composed of low weight, and good adhesion, dispersibility, and flowability, and high electrical conductivity.

This dispersion of the invention for the application of a metal layer on a non-electrically-conductive substrate comprises, based on the total weight of components A, B, C, and D, which gives a total of 100% by weight,

a from 0.1 to 99.8% by weight, preferably from 2 to 87.5% by weight, particularly preferably from 4 to 80% by weight, of component A,

b from 0.1 to 30% by weight, preferably from 0.5 to 20% by weight, particularly preferably from 1 to 15% by weight, of component B,

c from 0.1 to 70% by weight, preferably from 2 to 65% by weight, particularly preferably from 4 to 55% by weight, of component C, and

d from 0 to 99.7% by weight, preferably from 10 to 95.5% by weight, particularly preferably from 15 to 91% by weight, of component D.

The dispersion of the invention can comprise not only the components A to D mentioned but also at least one of the following components:

e from 0.1 to 20% by weight, preferably from 0.5 to 10% by weight, particularly preferably from 1 to 6% by weight, based on the total weight of components A-D, of a dispersing agent component E; and also

f from 0.1 to 40% by weight, preferably from 0.5. to 30% by weight, particularly preferably from 1 to 10% by weight, based on the total weight of components A-D, of at least one further additive F.

Component A is described below under component A′, component D under component C′, component E under component D′, and component F under component E′.

The invention has found that exfoliated graphite gives excellent results when replacing carbon nanotubes and provides an uncomplicated method of producing thermoplastic moldings which can be metallized by an electroplating method and, respectively, of providing coating dispersions. Very small amounts of exfoliated graphite can be used here.

The thermoplastic molding compositions of the invention generally comprise from 0.1 to 30% by weight, preferably from 0.5 to 10% by weight, particularly preferably from 1 to 8% by weight, in particular from 1 to 5% by weight, of exfoliated graphite. The amount here is based on the entire molding composition.

Exfoliated graphite is known per se. It is usually produced by using a vaporizable solvent for intercalation in graphite, the intercalated graphite being expanded. The layers are then separated from one another, preferably giving very thin graphite layers. The thickness of the graphite layers is ideally only that of one atomic sublayer. For practical applications, preference is given to exfoliated graphite particles whose thickness is from 1 to 5000 atomic layers, preferably from 1 to 500 atomic layers, particularly preferably from 1 to 50 atomic layers, specifically from 1 to 30 atomic layers. Typical suitable layer thicknesses are in the range from 1 to 1000 nm, preferably from 1 to 100 nm, particularly preferably from 1 to 20 nm, specifically from 1 to 15 nm.

The surface area of these exfoliated graphite particles that can be used with preference in the invention is preferably from 300 to 2600 m²/g. Surface areas of from 600 to 2000 m²/g are preferred.

Exfoliated graphite particles and their production are known per se and are described by way of example in US 2006/0241237 and US 2007/0092432. WO 2007/136559 also describes conductive coatings composed of expanded graphite. Exfoliated graphite nanoplatelets are also described, and these are said to be capable of introduction into polymers to increase their conductivity. According to this specification, the exfoliated graphite particles are typically used for a surface coating on glass fibers, and then the glass fibers can be colored by electrostatic coating. US 2006/0241237 more particularly relates to a device for the expansion of non-expanded intercalated graphite in the presence of a gaseous atmosphere. The length of the platelets described there, which can also be used in the invention, is less than 300 μm, and their thickness is less than about 0.1 μm, preferably less than 20 nm, more particularly less than 15 nm. The graphite particles are said to be capable of introduction into polymer molding compositions in amounts of up to 50% by volume. In the case of epoxy resins, amounts of less than about 8% by volume are considered adequate. The expanded graphite particles are produced by treatment with radio frequency.

The surface areas of the exfoliated graphite particles described in US 2007/0092432 are in the range from 300 m²/g to 2600 m²/g. The invention can also use these exfoliated graphite particles. It is stated that complete exfoliation of the graphite to give individual graphite layers has hitherto been impossible. It is moreover stated that the fillers can be admixed with thermoplastic molding compositions in order to increase their conductivity.

Exfoliated graphite particles used in the invention can be produced by any desired suitable processes, for example those listed in the specifications described above.

Reference can also be made to M. Zhang et al., Journal of Applied Polymer Science, Vol. 108, pages 1482 to 1489 (2008), where expanded graphite particles are likewise described for use in thermoplastic molding compositions. Reference can be made to that publication and to the references mentioned therein for useful expanded graphite particles and exfoliated graphite particles.

Other exfoliated graphite particles useful in the invention are moreover obtainable as xGnP from XG Sciences, Inc., 5020 North Wind Drive, Suite 212, East Lansing, Mich. 48823. The platelets are composed of numerous graphene layers with a total thickness of about 5 nm, or with a range from 1 nm to 15 nm. The particle diameters are in the range from below 1 μm to more than 100 μm. Density is about 2.0 g/cm³. Electrical resistance is about 50×10⁻⁶ ohm cm. Thermal conductivity is about 3000 W/m K.

Nature, Vol. 442, Jul. 20, 2006, pages 282 to 286 describes other graphenes or graphene-based composite materials which are useful in the invention. The graphene layers described there are obtained from graphite oxide. Graphite oxide is produced here by the Hummers method. The product was then treated with DMF and finally with phenyl isocyanate. It was introduced into polymers such as acrylonitrile-butadiene-styrene, and also styrene-butadiene rubber. The invention can also use exfoliated graphite oxides instead of exfoliated graphite particles. These are likewise covered by the term “exfoliated graphite”.

Exfoliated graphite oxide which can be used in the invention can also be produced as described by Lod Ruff of North Western University in Chicago, USA. For this, graphite is first oxidized by an acid, and the resultant graphite oxide is exfoliated in water, to give graphene oxide flakes. These graphene oxide flakes can be used in the invention, see Nanomaterials News, Vol. 3, issue 12, Aug. 21, 2007, page 2, Pira International Ltd. 2007 (Intertech Pira. Com.). Page 6 in the same issue describes other suitable graphenes.

For other suitable graphenes, reference can be made to B. Trauzettel, Physik Journal 6 (2007), No. 7, pages 39 to 44.

It has been found that, in relation to the thermoplastic molding compositions of the invention which are subsequently metallized by an electroplating method, even very small amounts of exfoliated graphite are adequate to ensure metallizability. In this respect the molding compositions are also advantageous over molding compositions which comprise carbon nanotubes. Use of relatively small amounts of graphite permits retention of the mechanical properties and processing properties of the thermoplastic molding compositions. Exfoliated graphite moreover has a great cost advantage over carbon nanotubes, and it is therefore also possible to produce relatively large moldings at low cost.

The exfoliated graphite particles are sometimes also termed graphite particles below, but these graphite particles throughout the description and the claims are exfoliated graphite particles.

The processes of the invention, and also the other articles, processes, and uses of the invention are described below.

An essential feature of the processes of the invention is that the substrate surface of the substrate to be metallized comprises exfoliated graphite. This means that exfoliated graphite is either comprised within the substrate itself—and therefore also at its surface—or else that exfoliated graphite in the form of an adherent polymer coating or of a lacquer is applied to a substrate which itself does not comprise any exfoliated graphite. The exfoliated graphite located in or at the substrate surface brings about electrical conductivity, which is indispensable for the subsequent metal deposition process by a chemical and/or electroplating method. By way of example, electrical conductivity can be increased in or at the substrate surface not only by the presence of the exfoliated graphite but also by the presence of other electrically conductive components, examples being metal powders or carbon black particles, but their presence is not essential to the invention.

In preferred embodiments of the processes of the invention, therefore, substrates used in the process of metal deposition by a chemical and/or electroplating method are those produced from a molding composition described in more detail below. In other preferred embodiments of the processes of the invention, substrates used in the process of metal deposition by a chemical and/or electroplating method are those which have been provided with a dispersion described in more detail below and then have been at least partially dried and/or at least partially hardened.

Molding Compositions

In one preferred embodiment, the substrates that can be used in the processes of the invention are based on thermoplastic molding compositions comprising, based on the total weight of components A, B, C, and D, which gives a total of 100% by weight,

a from 20 to 99% by weight, preferably from 55 to 95% by weight, particularly preferably from 60 to 92% by weight, of component A,

b from 1 to 30% by weight, preferably from 5 to 25% by weight, particularly preferably from 8 to 20% by weight, of component B,

c from 0 to 10% by weight, preferably from 0 to 8% by weight, particularly preferably from 0 to 5% by weight, of component C, and

d from 0 to 40% by weight, preferably from 0 to 30% by weight, particularly preferably from 0 to 10% by weight, of component D.

The individual components of these molding compositions are described below:

Component A

In principle, any of the thermoplastic polymers is suitable as component A. In general, the thermoplastic polymers have a tensile strain at break in the range from 10% to 1000%, preferably in the range from 20 to 700, particularly preferably in the range from 50 to 500 (these and all of the other values mentioned in this application for tensile strain at break and tensile strength being determined in the tensile test to ISO 527-2:1996 on type 1BA test specimens (annex A of the standard mentioned: “small test specimens”)).

Examples of a suitable component A are polyethylene, polypropylene, polyvinyl chloride, polystyrene (impact-resistant or non-impact-modified), ABS (acrylonitrile-butadiene-styrene), ASA (acrylonitrile-styrene-acrylate), MABS (transparent ABS, comprising methacrylate units), styrene-butadiene block copolymer (e.g. Styroflex® or Styrolux® from BASF Aktiengesellschaft, K-Resin™ from CPC), polyamides, polyethylene terephthalate (PET), polyethylene terephthalate glycol (PETG), polybutylene terephthalate (PBT), polyesters, aliphatic-aromatic copolyesters (e.g. Ecoflex® from BASF Aktiengesellschaft), polycarbonate (e.g. Makrolon® from Bayer AG), polymethyl methacrylate (PMMA), poly(ether) sulfones, and polyphenylene oxide (PPO).

Epoxy resins can also be used.

As component A, preference is given to the use of one or more polymers selected from the group of impact-modified vinylaromatic copolymers, of thermoplastic elastomers based on styrene, of polyolefins, of aliphatic-aromatic copolyesters, of polycarbonates, and of thermoplastic polyurethanes. Polyamides can be used as likewise preferred component A.

Impact-Modified Vinylaromatic Copolymers:

Preferred impact-modified vinylaromatic copolymers are impact-modified copolymers composed of vinylaromatic monomers and of vinyl cyanides (SAN). The preferred impact-modified SAN used comprises ASA polymers and/or ABS polymers, or else (meth)acrylate-acrylonitrile-butadiene-styrene polymers (“MABS”, transparent ABS), or else blends of SAN, ABS, ASA, and MABS with other thermoplastics, for example with polycarbonate, with polyamide, with polyethylene terephthalate, with polybutylene terephthalate, with PVC, or with polyolefins.

The tensile strain at break values of the ASA and ABS that can be used as components A are generally from 10% to 300%, preferably from 15 to 250%, particularly preferably from 20% to 200%.

ASA polymers are generally impact-modified SAN polymers which comprise elastomeric graft copolymers of vinylaromatic compounds, in particular styrene, and vinyl cyanides, in particular acrylonitrile, on polyalkyl acrylate rubbers in a copolymer matrix composed, in particular, of styrene and/or α-methylstyrene and acrylonitrile.

In one preferred embodiment in which the thermoplastic molding compositions comprise ASA polymers, the elastomeric graft copolymer A^{R} of component A is composed of

a1 from 1 to 99% by weight, preferably from 55 to 80% by weight, in particular from 55 to 65% by weight, of a particulate graft base A1 with a glass transition temperature below 0° C.,

a2 from 1 to 99% by weight, preferably from 20 to 45% by weight, in particular from 35 to 45% by weight, of a graft A2 composed of the following monomers, based on A2,

a21 from 40 to 100% by weight, preferably from 65 to 85% by weight, of units of styrene, of a substituted styrene, or of a (meth)acrylate, or of a mixture of these, in particular of styrene and/or α-methylstyrene, as component A21, and

a22 up to 60% by weight, preferably from 15 to 35% by weight, of units of acrylonitrile or methacrylonitrile, in particular of acrylonitrile, as component A22.

The graft A2 here is composed of at least one graft shell.

Component A1 here is composed of the following monomers

a11 from 80 to 99.99% by weight, preferably from 95 to 99.9% by weight, of at least one C₁-C₈-alkyl acrylate, preferably n-butyl acrylate and/or ethylhexyl acrylate, as component A11,

a12 from 0.01 to 20% by weight, preferably from 0.1 to 5.0% by weight, of at least one polyfunctional crosslinking monomer, preferably diallyl phthalate and/or DCPA, as component A12.

According to one embodiment of the invention, the average particle size of component A^{R} is from 50 to 1000 nm, with monomodal distribution.

In another embodiment, the particle size distribution of component A^{R} is bimodal, from 60 to 90% by weight having an average particle size of from 50 to 200 nm, and from 10 to 40% by weight having an average particle size of from 50 to 400 nm, based on the total weight of component A^{R}.

The average particle size and particle size distribution given are the sizes determined from the cumulative weight distribution. The average particle sizes are in all cases the weight average of the particle sizes. The determination of these is based on the method of W. Scholtan and H. Lange, Kolloid-Z. and Z.-Polymere 250 (1972), pp. 782 -796, using an analytical ultracentrifuge. The ultracentrifuge measurement gives the cumulative weight distribution of the particle diameter of a specimen. From this it is possible to deduce what percentage by weight of the particles have a diameter identical to or smaller than a particular size. The average particle diameter, which is also termed the d₅₀ of the cumulative weight distribution, is defined here as that particle diameter at which 50% by weight of the particles have a diameter smaller than that corresponding to the d₅₀. Equally, 50% by weight of the particles then have a larger diameter than the d₅₀. To describe the breadth of the particle size distribution of the rubber particles, d₁₀ and d₉₀ values given by the cumulative weight distribution are utilized alongside the d₅₀ value (average particle diameter). The d₁₀ and d₉₀ of the cumulative weight distribution are defined similarly to the d₅₀ with the difference that they are based on, respectively, 10 and 90% by weight of the particles. The quotient

(d₉₀−d₁₀)/d₅₀=Q

is a measure of the breadth of the particle size distribution. Elastomeric graft copolymers A^{R} preferably have Q values of less than 0.5, in particular less than 0.35.

The acrylate rubbers A1 are preferably alkyl acrylate rubbers composed of one or more C₁₋₈-alkyl acrylates, preferably C₄₋₈-alkyl acrylates, preferably using at least some butyl, hexyl, octyl, or 2-ethylhexyl acrylate, in particular n-butyl and 2-ethylhexyl acrylate. Comonomers which may be present in these alkyl acrylate rubbers are up to 30% by weight of monomers which form hard polymers, examples being vinyl acetate, (meth)acrylonitrile, styrene, substituted styrene, methyl methacrylate, vinyl ethers.

The acrylate rubbers also comprise from 0.01 to 20% by weight, preferably from 0.1 to 5% by weight, of crosslinking, polyfunctional monomers (crosslinking monomers). Examples of these are monomers which comprise two or more double bonds capable of copolymerization, preferably not 1,3-conjugated.

Examples of suitable crosslinking monomers are divinylbenzene, diallyl maleate, diallyl fumarate, diallyl phthalate, diethyl phthalate, triallyl cyanurate, triallyl isocyanurate, tricyclodecenyl acrylate, dihydrodicyclopentadienyl acrylate, triallyl phosphate, allyl acrylate, allyl methacrylate. Dicyclopentadienyl acrylate (DCPA) has proven to be a particularly suitable crosslinking monomer (cf. DE-C 12 60 135).

Component A^{R} is a graft copolymer. The graft copolymers A^{R} have an average particle size d₅₀ of from 50 to 1000 nm, preferably from 50 to 800 nm, and particularly preferably from 50 to 600 nm. These particle sizes may be achieved if the graft base A1 used has a particle size of from 50 to 800 nm, preferably from 50 to 500 nm, and particularly preferably from 50 to 250 nm.

The graft copolymer A^{R} generally has one or more stages, i.e. is a polymer composed of a core and one or more shells. The polymer is composed of a first stage (graft core) A1 and of one or—preferably—more stages A2 (grafts) grafted onto this first stage and known as graft stages or graft shells.

Simple grafting or multiple stepwise grafting may be used to apply one or more graft shells to the rubber particles, and each of these graft shells may have a different makeup. In addition to the grafting monomers, polyfunctional crosslinking monomers or monomers comprising reactive groups may also be included in the grafting process (see, for example, EP-A 230 282, DE-B 36 01 419, EP-A 269 861).

In one preferred embodiment, component A^{R} is composed of a graft copolymer built up in two or more stages, the graft stages generally being produced from resin-forming monomers and having a glass transition temperature T_{g} above 30° C., preferably above 50° C. The structure having two or more stages serves, inter alia, to make the rubber particles A^{R} (partially) compatible with the thermoplastic matrix.

An example of a production method for graft copolymers A^{R} is grafting of at least one of the monomers A2 listed below onto at least one of the graft bases or graft core materials A1 listed above.

In one embodiment of the invention, the graft base A1 is composed of from 15 to 99% by weight of acrylate rubber, from 0.1 to 5% by weight of crosslinker, and from 0 to 49.9% by weight of one of the stated other monomers or rubbers.

Suitable monomers for forming the graft A2 are styrene, α-methylstyrene, (meth)acrylates, acrylonitrile, and methacrylonitrile, in particular acrylonitrile.

In one embodiment of the invention, crosslinked acrylate polymers with a glass transition temperature below 0° C. serve as graft base A1. The crosslinked acrylate polymers are preferably to have a glass transition temperature below −20° C., in particular below −30° C.

In one preferred embodiment, the graft A2 is composed of at least one graft shell, and the outermost graft shell of these has a glass transition temperature of more than 30° C., while a polymer formed from the monomers of the graft A2 would have a glass transition temperature of more than 80° C.

Suitable production processes for graft copolymers A^{R} are emulsion, solution, bulk or suspension polymerization. The graft copolymers A^{R} are preferably produced by free-radical emulsion polymerization in the presence of lattices of component A1 at temperatures of from 20° C. to 90° C., using water-soluble or oil-soluble initiators, such as peroxodisulfate or benzoyl peroxide, or with the aid of redox initiators. Redox initiators are also suitable for polymerization below 20° C.

Suitable emulsion polymerization processes are described in DE-A 28 26 925, 31 49 358, and DE-C 12 60 135.

The graft shells are preferably built up in the emulsion polymerization process described in DE-A 32 27 555, 31 49 357, 31 49 358, 34 14 118. The defined setting of the particle sizes at from 50 to 1000 nm preferably takes place by the processes described in DE-C 12 60 135 and DE-A 28 26 925, and Applied Polymer Science, volume 9 (1965), p. 2929. The use of polymers with different particle sizes is known from DE-A 28 26 925 and U.S. Pat. No. 5,196,480, for example.

The process described in DE-C 12 60 135 begins by producing the graft base A1 by polymerizing in a known manner, at temperatures of from 20 to 100° C., preferably from 50 to 80° C., the acrylate(s) used in one embodiment of the invention and the polyfunctional crosslinking monomer, if appropriate together with the other comonomers, in aqueous emulsion. Use may be made of the usual emulsifiers, such as alkali metal alkyl- or alkylarylsulfonates, alkyl sulfates, fatty alcohol sulfonates, salts of higher fatty acids having from 10 to 30 carbon atoms or resin soaps. It is preferable to use the sodium salts of alkylsulfonates or fatty acids having from 10 to 18 carbon atoms. In one embodiment, the amounts used of the emulsifiers are from 0.5 to 5% by weight, in particular from 1 to 2% by weight, based on the monomers used in producing the graft base A1. Operations are generally carried out with a ratio of water to monomers of from 2:1 to 0.7:1 by weight. The polymerization initiators used are in particular the commonly used persulfates, such as potassium persulfate. However, it is also possible to use redox systems. The amounts generally used of the initiators are from 0.1 to 1% by weight, based on the monomers used in producing the graft base A1. Other polymerization auxiliaries which may be used during the polymerization are the usual buffer substances which can set a preferred pH of from 6 to 9, examples being sodium bicarbonate and sodium pyrophosphate, and also from 0 to 3% by weight of a molecular weight regulator, such as mercaptans, terpinols or dimeric α-methylstyrene.

The precise polymerization conditions, in particular the nature, feed parameters, and amount of the emulsifier, are determined individually within the ranges given above in such a way that the resultant latex of the crosslinked acrylate polymer has a d₅₀ in the range from about 50 to 800 nm, preferably from 50 to 500 nm, particularly preferably in the range from 80 to 250 nm. The particle size distribution of the latex here is preferably intended to be narrow.

In one embodiment of the invention, to produce the graft polymer A^{R}, in a following step, in the presence of the resultant latex of the crosslinked acrylate polymer, a monomer mixture composed of styrene and acrylonitrile is polymerized, and in one embodiment of the invention here the weight ratio of styrene to acrylonitrile in the monomer mixture should be in the range from 100:0 to 40:60, and preferably from 65:35 to 85:15. This graft copolymerization of styrene and acrylonitrile onto the crosslinked polyacrylate polymer serving as a graft base is again advantageously carried out in aqueous emulsion under the usual conditions described above. The graft copolymerization may usefully take place in the system used for the emulsion polymerization to produce the graft base A1, where further emulsifier and initiator may be added if necessary. The mixture of styrene and acrylonitrile monomers which is to be grafted on in one embodiment of the invention may be added to the reaction mixture all at once, in portions in more than one step, or preferably continuously during the course of the polymerization. The graft copolymerization of the mixture of styrene and acrylonitrile in the presence of the crosslinking acrylate polymer is carried out in such a way as to obtain in graft copolymer A^{R} a degree of grafting of from 1 to 99% by weight, preferably from 20 to 45% by weight, in particular from 35 to 45% by weight, based on the total weight of component A^{R}. Since the grafting yield in the graft copolymerization is not 100%, the amount of the mixture of styrene and acrylonitrile monomers which has to be used in the graft copolymerization is somewhat greater than that which corresponds to the desired degree of grafting. Control of the grafting yield in the graft copolymerization, and therefore of the degree of grafting of the finished graft copolymer A^{R}, is a topic with which the person skilled in the art is familiar. It may be achieved, for example, via the metering rate of the monomers or via addition of regulators (Chauvel, Daniel, ACS Polymer Preprints 15 (1974), pp. 329 ff.). The emulsion graft copolymerization generally gives approximately 5 to 15% by weight, based on the graft copolymer, of free, ungrafted styrene-acrylonitrile copolymer. The proportion of the graft copolymer A^{R} in the polymerization product obtained in the graft copolymerization is determined by the method given above.

Production of the graft copolymers A^{R} by the emulsion process also gives, besides the technical process advantages stated above, the possibility of reproducible changes in particle sizes, for example by agglomerating the particles at least to some extent to give larger particles. This implies that polymers with different particle sizes may also be present in the graft copolymers A^{R}.

Component A^{R} composed of graft base and graft shell(s) can in particular be ideally adapted to the respective application, in particular with regard to particle size.

The graft copolymers A^{R} generally comprise from 1 to 99% by weight, preferably from 55 to 80% by weight, and particularly preferably from 55 to 65% by weight, of graft base A1 and from 1 to 99% by weight, preferably from 20 to 45% by weight, particularly preferably from 35 to 45% by weight, of the graft A2, based in each case on the entire graft copolymer.

ABS polymers are generally understood to be impact-modified SAN polymers in which diene polymers, in particular poly-1,3-butadiene, are present in a copolymer matrix, in particular of styrene and/or α-methylstyrene, and acrylonitrile.

In one preferred embodiment, in which the thermoplastic molding compositions comprise ABS polymers, the elastomeric graft copolymer A^{R} of component A is composed of

a1′ from 10 to 90% by weight of at least one elastomeric graft base with a glass transition temperature below 0° C., obtainable by polymerizing, based on A1′,

a11′ from 60 to 100% by weight, preferably from 70 to 100% by weight, of at least one conjugated diene and/or C₁-C₁₀-alkyl acrylate, in particular butadiene, isoprene, n-butyl acrylate and/or 2-ethylhexyl acrylate,

a12′ from 0 to 30% by weight, preferably from 0 to 25% by weight, of at least one other monoethylenically unsaturated monomer, in particular styrene, α-methyl-styrene, n-butyl acrylate, methyl methacrylate, or a mixture of these, and among the last-named in particular butadiene-styrene copolymers and n-butyl acrylate-styrene copolymers, and

a13′ from 0 to 10% by weight, preferably from 0 to 6% by weight, of at least one crosslinking monomer, preferably divinylbenzene, diallyl maleate, allyl (meth)acrylate, dihydrodicyclopentadienyl acrylate, divinyl esters of dicarboxylic acids, such as succinic and adipic acid, and diallyl and divinyl ethers of bifunctional alcohols, such as ethylene glycol or butane-1,4-diol,

a2′ from 10 to 60% by weight, preferably from 15 to 55% by weight, of a graft A2′, composed of, based on A2′,

a21′ from 50 to 100% by weight, preferably from 55 to 90% by weight, of at least one vinylaromatic monomer, preferably styrene and/or α-methylstyrene,

a22′ from 5 to 35% by weight, preferably from 10 to 30% by weight, of acrylonitrile and/or methacrylonitrile, preferably acrylonitrile,

a23′ from 0 to 50% by weight, preferably from 0 to 30% by weight, of at least one other monoethylenically unsaturated monomer, preferably methyl methacrylate and n-butyl acrylate.

In another preferred embodiment in which the thermoplastic molding compositions comprise ABS, component A^{R′} is a graft rubber with bimodal particle size distribution, composed of, based on A^{R′};

a1″ from 40 to 90% by weight, preferably from 45 to 85% by weight, of an elastomeric particulate graft base A1″, obtainable by polymerizing, based on A1″,

a11″ from 70 to 100% by weight, preferably from 75 to 100% by weight, of at least one conjugated diene, in particular butadiene and/or isoprene,

a12″ from 0 to 30% by weight, preferably from 0 to 25% by weight, of at least one other monoethylenically unsaturated monomer, in particular styrene, α-methyl-styrene, n-butyl acrylate, or a mixture of these,

a2″ from 10 to 60% by weight, preferably from 15 to 55% by weight, of a graft A2″ composed of, based on A2″,

a21″ from 65 to 95% by weight, preferably from 70 to 90% by weight, of at least one vinylaromatic monomer, preferably styrene,

a22″ from 5 to 35% by weight, preferably from 10 to 30% by weight, of acrylonitrile,

a23″ from 0 to 30% by weight, preferably from 0 to 20% by weight, of at least one other monoethylenically unsaturated monomer, preferably methyl methacrylate and n-butyl acrylate.

In one preferred embodiment, in which the thermoplastic molding compositions comprise ASA polymers as component A, the hard matrix A^{M} of component A is at least one hard copolymer which comprises units which derive from vinylaromatic monomers, and comprising, based on the total weight of units deriving from vinylaromatic monomers, from 0 to 100% by weight, preferably from 40 to 100% by weight, particularly preferably from 60 to 100% by weight, of units deriving from α-methylstyrene, and comprising from 0 to 100% by weight, preferably from 0 to 60% by weight, particularly preferably from 0 to 40% by weight, of units deriving from styrene, composed of, based on A^{M},

a^{M}1 from 40 to 100% by weight, preferably from 60 to 85% by weight, of vinylaromatic units, as component A^{M}1,

a^{M}2 up to 60% by weight, preferably from 15 to 40% by weight, of units of acrylonitrile or of methacrylonitrile, in particular of acrylonitrile, as component A^{M}2.

In one preferred embodiment, in which the thermoplastic molding compositions comprise ABS polymers as component A, the hard matrix A^{M′} of component A is at least one hard copolymer which comprises units which derive from vinylaromatic monomers, and comprising, based on the total weight of units deriving from vinylaromatic monomers, from 0 to 100% by weight, preferably from 40 to 100% by weight, particularly preferably from 60 to 100% by weight, of units deriving from α-methylstyrene, and from 0 to 100% by weight, preferably from 0 to 60% by weight, particularly preferably from 0 to 40% by weight, of units deriving from styrene, composed of, based on A^{M′},

a^{M}1′ from 50 to 100% by weight, preferably from 55 to 90% by weight, of vinylaromatic monomers,

a^{M}2′ from 0 to 50% by weight of acrylonitrile or methacrylonitrile or a mixture of these,

a^{M}3′ from 0 to 50% by weight of at least one other monoethylenically unsaturated monomer, such as methyl methacrylate and N-alkyl- or N-arylmaleimides, e.g. N-phenylmaleimide.

In another preferred embodiment, in which the thermoplastic molding compositions comprise ABS as component A, component A^{M′} is at least one hard copolymer with a viscosity number VN (determined to DIN 53726 at 25° C. in 0.5% strength by weight solution in dimethylformamide) of from 50 to 120 ml/g, comprising units which derive from vinylaromatic monomers, and comprising, based on the total weight of units deriving from vinylaromatic monomers, from 0 to 100% by weight, preferably from 40 to 100% by weight, particularly preferably from 60 to 100% by weight, of units deriving from α-methylstyrene, and from 0 to 100% by weight, preferably from 0 to 60% by weight, particularly preferably from 0 to 40% by weight, of units deriving from styrene, composed of, based on A^{M′},

a_{M}1″ from 69 to 81% by weight, preferably from 70 to 78% by weight, of vinylaromatic monomers,

a_{M}2″ from 19 to 31% by weight, preferably from 22 to 30% by weight, of acrylonitrile,

a_{M}3″ from 0 to 30% by weight, preferably from 0 to 28% by weight, of at least one other monoethylenically unsaturated monomer, such as methyl methacrylate or N-alkyl- or N-arylmaleimides, e.g. N-phenylmaleimide.

In one embodiment the ABS polymers comprise, alongside one another, components A^{M′} whose viscosity numbers VN differ from each other by at least five units (ml/g) and/or whose acrylonitrile contents differ from each other by five units (% by weight). Finally, alongside component A^{M′} and the other embodiments, there may also be copolymers present of (α-methyl)styrene with maleic anhydride or maleimides, of (α-methyl)styrene with maleimides and methyl methacrylate or acrylonitrile, or of (α-methyl)styrene with maleimides, methyl methacrylate, and acrylonitrile.

In these ABS polymers, the graft polymers A^{R′} are preferably obtained by means of emulsion polymerization. The mixing of the graft polymers A^{R′} with components A^{M′}, and, if appropriate, other added materials, generally takes place in a mixing apparatus, producing a substantially molten polymer mixture. It is advantageous for the molten polymer mixture to be cooled very rapidly.

In other respects, the production process and general embodiments, and particular embodiments, of the abovementioned ABS polymers are described in detail in the German patent application DE-A 19728629, expressly incorporated herein by way of reference.

The ABS polymers mentioned may comprise other conventional auxiliaries and fillers. Examples of these substances are lubricants or mold-release agents, waxes, pigments, dyes, flame retardants, antioxidants, light stabilizers, or antistatic agents.

According to one preferred embodiment of the invention, the viscosity number of the hard matrices A^{M} and, respectively, A^{M′} of component A is from 50 to 90, preferably from 60 to 80.

The hard matrices A^{M} and A^{M′} of component A are preferably amorphous polymers. According to one embodiment of the invention, mixtures of a copolymer of styrene with acrylonitrile and of a copolymer composed of α-methylstyrene with acrylonitrile are used as hard matrices A^{M} and, respectively, A^{M′} of component A. The acrylonitrile content in these copolymers of the hard matrices is from 0 to 60% by weight, preferably from 15 to 40% by weight, based on the total weight of the hard matrix. The hard matrices A^{M} and, respectively, A^{M′} of component A also include the free, ungrafted (α-methyl)styrene-acrylonitrile copolymers produced during the graft copolymerization reaction to produce component A^{R} and, respectively, A^{R′}. Depending on the conditions selected during the graft copolymerization reaction for producing the graft copolymers A^{R} and, respectively, A^{R′}, it can be possible for a sufficient proportion of hard matrix to have been formed before the graft copolymerization reaction has ended. However, it will generally be necessary for the products obtained during the graft copolymerization reaction to be blended with additional, separately produced hard matrix.

The additional, separately prepared hard matrices A^{M} and, respectively, A^{M′} of component A may be obtained by the conventional processes. For example, according to one embodiment of the invention the copolymerization reaction of the styrene and/or α-methylstyrene with the acrylonitrile may be carried out in bulk, solution, suspension, or aqueous emulsion. The viscosity number of components A^{M} and, respectively, A^{M′} is preferably from 40 to 100, with preference from 50 to 90, in particular from 60 to 80. The viscosity number here is determined to DIN 53 726, dissolving 0.5 g of material in 100 ml of dimethylformamide.

The mixing of components A^{R} (and, respectively, A^{R′}) and A^{M} (and, respectively, A^{M′}) may take place in any desired manner by any of the known methods. If, by way of example, these components have been produced via emulsion polymerization, it is possible to mix the resultant polymer dispersions with one another, then to precipitate the polymers together and work up the polymer mixture. However, these components are preferably blended via extruding, kneading or rolling the components together, the components having been isolated, if necessary, in advance from the aqueous dispersion or solution obtained during the polymerization reaction. The graft copolymerization products obtained in aqueous dispersion may also be only partially dewatered and mixed in the form of moist crumb with the hard matrix, whereupon then the complete drying of the graft copolymers takes place during the mixing process.

Styrene-Based Thermoplastic Elastomers:

Preferred styrene-based thermoplastic elastomers (S-TPE) are those whose tensile strain at break is more than 300%, particularly preferably more than 500%, in particular more than 500% to 600%. The S-TPE admixed particularly preferably comprises a linear or star-shaped styrene-butadiene block copolymer having external polystyrene blocks S and, situated between these, styrene-butadiene copolymer blocks having random styrene/butadiene distribution (S/B)_{random} or having a styrene gradient (S/B)ₜₐₚₑᵣ (e.g. Styroflex® or Styrolux® from BASF Aktiengesellschaft, or K-Resin™ from CPC).

The total butadiene content is preferably in the range from 15 to 50% by weight, particularly preferably in the range from 25 to 40% by weight, and the total styrene content is correspondingly preferably in the range from 50 to 85% by weight, particularly preferably in the range from 60 to 75% by weight.

The styrene-butadiene block (S/B) is preferably composed of from 30 to 75% by weight of styrene and from 25 to 70% by weight of butadiene. An (S/B) block particularly preferably has a butadiene content of from 35 to 70% by weight and a styrene content of from 30 to 65% by weight.

The content of the polystyrene blocks S is preferably in the range from 5 to 40% by weight, in particular in the range from 25 to 35% by weight, based on the entire block copolymer. The content of the copolymer blocks S/B is preferably in the range from 60 to 95% by weight, in particular in the range from 65 to 75% by weight.

Particular preference is given to linear styrene-butadiene block copolymers of the general structure S-(S/B)-S having, situated between the two S blocks, one or more (S/B)_{random} blocks having random styrene/butadiene distribution. Block copolymers of this type are obtainable via anionic polymerization in a non-polar solvent with addition of a polar cosolvent or of a potassium salt, as described by way of example in WO 95/35335 or WO 97/40079.

The vinyl content is the relative content of 1,2-linkages of the diene units, based on the entirety of 1,2-, and 1,4-cis and 1,4-trans linkages. The 1,2-vinyl content in the styrene/butadiene copolymer block (S/B) is preferably below 20%, in particular in the range from 10 to 18%, particularly preferably in the range from 12 to 16%.

Polyolefins:

The tensile strain at break values of polyolefins that can be used as components A are generally from 10% to 600%, preferably from 15% to 500%, particularly preferably from 20% to 400%.

Examples of suitable components A are semicrystalline polyolefins, such as homo- or copolymers of ethylene, propylene, 1-butene, 1-pentene, 1-hexene, or 4-methyl-1-pentene, or else ethylene copolymers with vinyl acetate, vinyl alcohol, ethyl acrylate, butyl acrylate, or methacrylate. The component A used preferably comprises a high-density polyethylene (HDPE), low-density polyethylene (LDPE), linear low-density polyethylene (LLDPE), polypropylene (PP), ethylene-vinyl acetate copolymer (EVA), or ethylene-acrylic copolymer. A particularly preferred component A is polypropylene.

Polycarbonates:

The polycarbonates that can be used as components A generally have tensile strain at break values of from 20% to 300%, preferably 30% to 250%, particularly preferably 40% to 200%.

The molar mass of polycarbonates suitable as component A (weight average M_{W}, determined by means of gel permeation chromatography in tetrahydrofuran against polystyrene standards) is preferably in the range from 10 000 to 60 000 g/mol. By way of example, they are obtainable by the processes of DE-B-1 300 266 via interfacial polycondensation or according to the process of DE-A-1 495 730 via reaction of diphenyl carbonate with bisphenols. Preferred bisphenol is 2,2-di(4-hydroxy-phenyl)propane, generally—and also hereinafter—termed bisphenol A.

Instead of bisphenol A, it is also possible to use other aromatic dihydroxy compounds, in particular 2,2-di(4-hydroxyphenyl)pentane, 2,6-dihydroxynaphthalene, 4,4′-di-hydroxydiphenyl sulfone, 4,4′-dihydroxydiphenyl ether, 4,4′-dihydroxydiphenyl sulfite, 4,4′-dihydroxydiphenylmethane, 1,1-di(4-hydroxyphenyl)ethane, 4,4-dihydroxydiphenyl, or dihydroxydiphenylcycloalkanes, preferably dihydroxydiphenylcyclohexanes, or dihydroxycyclopentanes, in particular 1,1-bis(4-hydroxyphenyl)-3,3,5-trimethylcyclo-hexane, or else a mixture of the abovementioned dihydroxy compounds.

Particularly preferred polycarbonates are those based on bisphenol A or bisphenol A together with up to 80 mol % of the abovementioned aromatic dihydroxy compounds.

Polycarbonates with particularly good suitability as component A are those which comprise units that derive from resorcinol esters or from alkylresorcinol esters, for example those described in WO 00/61664, WO 00/15718, or WO 00/26274. These polycarbonates are marketed by way of example by General Electric Company, the trademark being SolIX®.

It is also possible to use copolycarbonates according to U.S. Pat. No. 3,737,409, and copolycarbonates based on bisphenol A and di(3,5-dimethyldihydroxyphenyl) sulfone are of particular interest here, and feature high heat resistance. It is also possible to use mixtures of different polycarbonates.

The average molar masses (weight average M_{W}, determined by means of gel permeation chromatography in tetrahydrofuran against polystyrene standards) of the polycarbonates are in the range from 10 000 to 64 000 g/mol. They are preferably in the range from 15 000 to 63 000 g/mol, in particular in the range from 15 000 to 60 000 g/mol. This means that the relative solution viscosities of the polycarbonates are in the range from 1.1 to 1.3, measured in 0.5% strength by weight solution in dichloromethane at 25° C., preferably from 1.15 to 1.33. The difference between the relative solution viscosities of the polycarbonates used is preferably not more than 0.05, in particular not more than 0.04.

The form in which the polycarbonates are used may either be that of regrind or else that of pellets.

Thermoplastic Polyurethane:

Any aromatic or aliphatic thermoplastic polyurethane is generally suitable as component A, and amorphous aliphatic thermoplastic polyurethanes which are transparent have preferred suitability: Aliphatic thermoplastic polyurethanes and their preparation are known to the person skilled in the art, for example from EP-B1 567 883 or DE-A 10321081, and are commercially available, for example with trademarks Texin® and Desmopan® from Bayer Aktiengesellschaft.

The Shore hardness D of preferred aliphatic thermoplastic polyurethanes is from 45 to 70, and their tensile strain at break values are from 30% to 800%, preferably from 50% to 600%, particularly preferably from 80% to 500%.

Particularly preferred components A are the styrene-based thermoplastic elastomers.

Component B

The thermoplastic molding compositions comprise, as component B, exfoliated graphite, as described above.

The exfoliated graphite can be added prior to, during, or after the polymerization of the monomers to give the thermoplastic polymer of component A. If the addition of the graphite takes place after the polymerization reaction, it preferably then takes place via addition to the thermoplastic melt in an extruder or preferably in a kneader. The compounding procedure in the kneader or extruder can in particular comminute the aggregates described above, to a substantial extent or even completely, the exfoliated graphite particles becoming dispersed in the thermoplastic matrix.

In one preferred embodiment, the graphite particles can be fed in the form of highly concentrated masterbatches in thermoplastics preferably selected from the group of the thermoplastics used as component A. The concentration of the graphite particles in the masterbatches is usually in the range from 5 to 50% by weight, preferably from 8 to 30% by weight, particularly preferably in the range from 12 to 22% by weight. The production of masterbatches is described by way of example in U.S. Pat. No. 5,643,502. The use of masterbatches can more particularly improve the comminution of the aggregates. By virtue of the processing to give the molding composition or the molding, the length distribution of the graphite particles in the molding composition or in the molding can be shorter than that originally used.

Component C

Any of the dispersing agents known to the person skilled in the art for use in plastics mixtures and disclosed within the prior art is in principle suitable for use as component C. Preferred dispersing agents are surfactants or surfactant mixtures, examples being anionic, cationic, amphoteric, or nonionic surfactants. Preference is furthermore given to the commercially available oligomeric and polymeric dispersing agents known to the person skilled in the art, these being described in CD Römpp Chemie Lexikon [CD edition of R\ddot{m}pp's Chemical Encyclopedia]—Version 3.0, Stuttgart/New York: Georg Thieme Verlag 2006, keyword “Dispergierhilfsmittel” [Dispersing agent].

Examples are polycarboxylic acids, polyamines, salts composed of long-chain polyamines and of polycarboxylic acids, amine-/amide-functional polyesters and polyacrylates, soy lecithins, polyphosphates, modified caseins. These polymeric dispersing agents can take the form of block copolymers, comb polymers, or random copolymers.

Cationic and anionic surfactants are described by way of example in “Encyclopedia of Polymer Science and Technology”, J. Wiley & Sons (1966), Volume 5, pp. 816 to 818, and in “Emulsion Polymerisation and Emulsion Polymers”, editors P. Lovell and M. El-Asser, Verlag Wiley & Sons (1997), pp. 224-226.

Examples of anionic surfactants are alkali metal salts of organic carboxylic acids having chain lengths of from 8 to 30 carbon atoms, preferably from 12 to 18 carbon atoms. These are generally termed soaps. The soaps usually used are the sodium, potassium, or ammonium salts. Other anionic surfactants which may be used are alkyl sulfates and alkyl- or alkylarylsulfonates having from 8 to 30 carbon atoms, preferably from 12 to 18 carbon atoms. Particularly suitable compounds are alkali metal dodecyl sulfates, e.g. sodium dodecyl sulfate or potassium dodecyl sulfate, and alkali metal salts of C₁₂-C₁₆ paraffinsulfonic acids. Other suitable compounds are sodium dodecyl-benzenesulfonate and sodium dioctyl sulfosuccinate.

Examples of suitable cationic surfactants are salts of amines or of diamines, quaternary ammonium salts, e.g. hexadecyltrimethylammonium bromide, and also salts of long-chain substituted cyclic amines, such as pyridine, morpholine, piperidine. Use is particularly made of quaternary ammonium salts of trialkylamines, e.g. hexadecyltrimethylammonium bromide. The alkyl radicals here preferably have from 1 to 20 carbon atoms.

Nonionic surfactants may in particular be used as component C. Nonionic surfactants are described by way of example in CD Römpp Chemie Lexikon—Version 1.0, Stuttgart/New York: Georg Thieme Verlag 1995, keyword “Nichtionische Tenside” [Nonionic surfactants].

Examples of suitable nonionic surfactants are polyethylene-oxide- or polypropylene-oxide-based substances, such as Pluronic® or Tetronic® from BASF Aktiengesellschaft. Polyalkylene glycols suitable as nonionic surfactants generally have a molar mass Mₙ in the range from 1000 to 15 000 g/mol, preferably from 2000 to 13 000 g/mol, particularly preferably from 4000 to 11 000 g/mol. Preferred nonionic surfactants are polyethylene glycols.

The polyalkylene glycols are known per se or may be produced by processes known per se, for example by anionic polymerization using alkali metal hydroxide catalysts, such as sodium hydroxide or potassium hydroxide, or using alkali metal alkoxide catalysts, such as sodium methoxide, sodium ethoxide, potassium ethoxide or potassium isopropoxide, and with addition of at least one starter molecule which comprises from 2 to 8 reactive hydrogen atoms, preferably from 2 to 6 reactive hydrogen atoms, or by cationic polymerization using Lewis acid catalysts, such as antimony pentachloride, boron fluoride etherate, or bleaching earth, the starting materials being one or more alkylene oxides having 2 to 4 carbon atoms in the alkylene radical.

Examples of suitable alkylene oxides are tetrahydrofuran, butylene 1,2- or 2,3-oxide, styrene oxide, and preferably ethylene oxide and/or propylene 1,2-oxide. The alkylene oxides may be used individually, alternating one after the other, or as a mixture. Examples of starter molecules which may be used are: water, organic dicarboxylic acids, such as succinic acid, adipic acid, phthalic acid, or terephthalic acid, aliphatic or aromatic, optionally N-mono-, or N,N- or N,N′-dialkyl-substituted diamines having from 1 to 4 carbon atoms in the alkyl radical, such as optionally mono- or dialkyl-substituted ethylenediamine, diethylenetriamine, triethylenetetramine, 1,3-propylenediamine, 1,3- or 1,4-butylenediamine, or 1,2-, 1,3-, 1,4-, 1,5- or 1,6-hexamethylenediamine.

Other starter molecules which may be used are: alkanolamines, e.g. ethanolamine, N-methyl- and N-ethylethanolamine, dialkanolamines, e.g. diethanolamine, and N-methyl- and N-ethyldiethanolamine, and trialkanolamines, e.g. triethanolamine, and ammonia. It is preferable to use polyhydric alcohols, in particular di- or trihydric alcohols or alcohols with functionality higher than three, for example ethanediol, 1,2-propanediol, 1,3-propanediol, diethylene glycol, dipropylene glycol, 1,4-butanediol, 1,6-hexanediol, glycerol, trimethylolpropane, pentaerythritol, sucrose, and sorbitol.

Other suitable components C are esterified polyalkylene glycols, such as the mono-, di-, tri- or polyesters of the polyalkylene glycols mentioned which can be produced by reacting the terminal OH groups of the polyalkylene glycols mentioned with organic acids, preferably adipic acid or terephthalic acid, in a manner known per se. Polyethylene glycol adipate or polyethylene glycol terephthalate is preferred as component C.

Particularly suitable nonionic surfactants are substances produced by alkoxylating compounds having active hydrogen atoms, for example adducts of ethylene oxide onto fatty alcohols, oxo alcohols, or alkylphenols. It is preferable to use ethylene oxide or 1,2-propylene oxide for the alkoxylation reaction.

Other preferred nonionic surfactants are alkoxylated or nonalkoxylated sugar esters or sugar ethers.

Sugar ethers are alkyl glycosides obtained by reacting fatty alcohols with sugars, and sugar esters are obtained by reacting sugars with fatty acids. The sugars, fatty alcohols, and fatty acids needed to produce the substances mentioned are known to the person skilled in the art.

Suitable sugars are described by way of example in Beyer/Walter, Lehrbuch der organischen Chemie [Textbook of organic chemistry], S. Hirzel Verlag Stuttgart, 19th edition, 1981, pp. 392 to 425. Particularly suitable sugars are D-sorbitol and the sorbitans obtained by dehydrating D-sorbitol.

Suitable fatty acids are saturated or singly or multiply unsaturated unbranched or branched carboxylic acids having from 6 to 26 carbon atoms, preferably from 8 to 22 carbon atoms, particularly preferably from 10 to 20 carbon atoms, for example as mentioned in CD Römpp Chemie Lexikon—Version 1.0, Stuttgart/New York: Georg Thieme Verlag 1995, keyword “Fettsäuren” [Fatty acids]. Preferred fatty acids are lauric acid, palmitic acid, stearic acid, and oleic acid.

The carbon skeleton of suitable fatty alcohols is identical with that of the compounds described as suitable fatty acids.

Sugar ethers, sugar esters, and the processes for their preparation are known to the person skilled in the art. Preferred sugar ethers are produced by known processes, by reacting the sugars mentioned with the fatty alcohols mentioned. Preferred sugar esters are produced by known processes, by reacting the sugars mentioned with the fatty acids mentioned. Preferred sugar esters are the mono-, di-, and triesters of the sorbitans with fatty acids, in particular sorbitan monolaurate, sorbitan dilaurate, sorbitan trilaurate, sorbitan monooleate, sorbitan dioleate, sorbitan trioleate, sorbitan monopalmitate, sorbitan dipalmitate, sorbitan tripalmitate, sorbitan monostearate, sorbitan distearate, sorbitan tristearate, and sorbitan sesquioleate, a mixture of sorbitan mono- and dioleates.

Component D

The thermoplastic molding compositions comprise, as component D, fibrous or particulate fillers different from component B, or a mixture of these. These are preferably commercially available products, for example carbon fibers and glass fibers. Carbon nanotubes can also be used.

Glass fibers that may be used may be composed of E, A, or C glass, and have preferably been treated with a size and with a coupling agent. Their diameter is generally from 6 to 20 μm. It is possible to use either continuous-filament fibers (rovings) or else chopped glass fibers (staple) whose length is from 1 to 10 mm, preferably from 3 to 6 mm.

It is also possible to add fillers or reinforcing materials, such as glass beads, mineral fibers, whiskers, aluminum oxide fibers, mica, powdered quartz, and wollastonite.

The thermoplastic molding compositions can moreover comprise other added materials which are typical and customary in plastics mixtures.

Added materials of this type which may be mentioned by way of example are: dyes, pigments, colorants, antistatic agents, antioxidants, stabilizers for improving heat resistance, for increasing resistance to light, for raising resistance to hydrolysis and to chemicals, agents to counter decomposition by heat, and in particular the lubricants that are advantageous for production of moldings. These other added materials may be metered in at any stage of the production process, but preferably at an early juncture, in order that the stabilizing effects (or other specific effects) of the added materials may be utilized at an early stage. Heat stabilizers or oxidation retarders are usually metal halides (chlorides, bromides, iodides) derived from metals of group I of the Periodic Table of the Elements (e.g. Li, Na, K, Cu).

Suitable stabilizers are the conventional hindered phenols, and also vitamin E or analogously structured compounds. HALS stabilizers (Hindered Amine Light Stabilizers), benzophenones, resorcinols, salicylates, benzotriazoles, such as Tinuvin® RP (the UV absorber 2-(2H-benzotriazol-2-yl)-4-methylphenol from CIBA), and other compounds are also suitable. The amounts of these usually used are up to 2% by weight (based on the entire thermoplastic molding composition mixture).

Suitable lubricants and mold-release agents are stearic acids, stearyl alcohol, stearic esters, and generally higher fatty acids, their derivatives, and corresponding fatty acid mixtures having from 12 to 30 carbon atoms. The amounts of these additives are in the range from 0.05 to 1% by weight.

Silicone oils, oligomeric isobutylene, or similar substances may also be used as added materials, and the usual amounts are from 0.05 to 5% by weight. It is also possible to use pigments, dyes, color brighteners, such as ultramarine blue, phthalocyanines, titanium dioxide, cadmium sulfides, derivatives of perylenetetracarboxylic acid.

The amounts usually used of processing aids and stabilizers, such as UV stabilizers, lubricants, and antistatic agents, are from 0.01 to 5% by weight.

Component C of the molding composition or dispersion comprising electrically conductive particles

A suitable component C is any of the electrically conductive particles with any desired geometry composed of any desired electrically conductive material, or composed of mixtures of various electrically conductive materials, or else composed of mixtures of electrically conductive and non-conductive materials, their average particle diameter being from 0.001 to 100 μm, preferably from 0.005 to 50 μm, particularly preferably from 0.01 to 10 μm (determined via laser diffraction measurement on Microtrac X100 equipment). For the purposes of the present invention, “electrically conductive particles” are particles whose electrical resistance is less than 10⁹ ohms. Examples of suitable electrically conductive materials are electrically conductive metal complexes, conductive organic compounds, or conductive polymers, e.g. polythiophenes or polypyrroles, metals, preferably zinc, nickel, copper, tin, cobalt, manganese, iron; magnesium, lead, chromium, bismuth, silver, gold, aluminum, titanium, palladium, platinum, tantalum, and also alloys thereof, or metal mixtures which comprise at least one of these metals. Examples of suitable alloys are CuZn, CuSn, CuNi, SnPb, SnBi, SnCo, NiPb, ZnFe, ZnNi, ZnCo, and ZnMn. Particular preference is given to aluminum, iron, copper, nickel, silver, tin, zinc, and their mixtures. Iron powder and copper powder are particularly preferred.

The metal can have non-metallic content alongside the metallic content. For example, there can be a coating on at least part of the surface of the metal. Suitable coatings can be inorganic (e.g. SiO₂, phosphates) or organic. The metal can also, of course, have been coated with another metal or with metal oxide. The metal can likewise be present in partially oxidized form.

The electrically conductive particles can in principle have any desired shape, examples of metal particles that can be used being acicular, lamellar, or spherical metal particles, preference being given to spherical and lamellar particles. Metal powders of this type are familiar commercial products or can be produced easily by means of known processes, for example via electrolytic deposition or chemical reduction from solutions of the metal salts or via reduction of an oxidic powder, for example by means of hydrogen, or via spraying or atomization of a metal melt, in particular in coolants, such as gases or water.

It is particularly preferable to use metal powders with spherical particles, in particular carbonyl iron powder.

The production of carbonyl iron powders via thermal decomposition of pentacarbonyliron is known and is described by way of example in Ullmann's

Encyclopedia of Industrial Chemistry, 5th Edition, Volume A14, page 599. By way of example, pentacarbonyliron can be decomposed at elevated temperatures in a heatable decomposition vessel which comprises a tube composed of a heat-resistant material, such as quartz glass or V2A steel preferably in a vertical position, surrounded by heating equipment, for example composed of heating tapes, of heating wires, or of a heating jacket through which a hot fluid flows.

The average particle diameters of the carbonyl iron powder as it is deposited can be controlled within a wide range via the process parameters and conduct of the decomposition reaction and are generally from 0.01 to 100 μm, preferably from 0.1 to 50 μm, particularly preferably from 1 to 10 μm.

If the intention is that two different metals form component C, this can be achieved via a mixture of two metals. It is particularly preferable that the two metals have been selected from the group consisting of aluminum, iron, copper, silver, zinc, and tin.

However, component C can also comprise a first metal and a second metal in that the second metal takes the form of an alloy (with the first metal or with one or more other metals), or component C comprises two different alloys. In these two instances, again, the metal components are in each case different from one another, and the shape of their metal particles can therefore be selected, independently of each other, to be identical or different.

Alongside the selection of the metals, the shape of the metal particles influences the properties of the dispersion of the invention, after a coating process. With respect to the shape, there are numerous variants known to the person skilled in the art. By way of example, the shape of the metal particle can be acicular, cylindrical, lamellar, or spherical. These particle shapes are idealized shapes, and the actual shape can, for example as a result of the production process, deviate to a small or great extent therefrom. For the purposes of the present invention, therefore, droplet-shaped particles are a practical deviation from the idealized spherical shape.

Metals with various particle shapes are available commercially.

If the shape of the metal particles of the metal components differs, it is preferable that the first component is spherical and the second component is lamellar or acicular.

In the case of different particle shapes, preference is likewise given to the following metals: aluminum, iron, copper, silver, zinc, and tin.

Component D is described above as component C, and component E is described above as component D.

Process for the Production of Metallizable Substrates or Moldings

The thermoplastic molding compositions composed of components A, B and, if present, C and D, and, respectively, E are produced by the process known to the person skilled in the art, for example by mixing of the components in the melt, using apparatuses known to the person skilled in the art, at temperatures which, as a function of the polymer A used, are usually in the range from 150° C. to 300° C., in particular from 200° C. to 280° C. Each of the polymers here can be introduced in pure form into the mixing apparatuses. However, it is also possible that individual components, for example A and B or A and C, are first premixed and then mixed with further components A, B, and/or C, or with other components, for example D. In one embodiment, a concentrate is first produced (these being known as additive masterbatches), for example from components B, C, or D, or E, in component A, and is then mixed with the desired amounts of the remaining components. The thermoplastic molding compositions can be pelletized by the process known to the person skilled in the art, in order by way of example to use extrusion, injection molding, calendering, or compression molding at a later juncture to process these to give metallizable moldings (i.e. substrates), such as foils or sheets, or composite layered foils or composite layered sheets. However, another possibility is that, directly after the mixing procedure, or in a single operation with the mixing procedure (i.e. simultaneous melt mixing and preferably extrusion, preferably by means of a screw extruder, or injection molding) they can be processed, in particular extruded or injection-molded, to give metallizable moldings, such as foils or sheets.

In one preferred embodiment of the processes by means of extrusion, the screw extruder has been designed as a single-screw extruder with at least one distributively mixing screw element.

In another preferred embodiment of the processes, the screw extruder has been designed as a twin-screw extruder with at least one distributively mixing screw element.

The processes for extrusion of the metallizable moldings can be carried out by methods which are known to the person skilled in the art and which are described in the prior art, examples being flat-film extrusion in the form of adaptor coextrusion or die coextrusion, and using apparatuses known to the person skilled in the art or described in the prior art.

The processes for injection-molding, calendering, or compression molding of the metallizable moldings are likewise known to the person skilled in the art and described in the prior art.

The total thickness of metallizable moldings in the form of foils or sheets is generally from 10 μm to 5 mm, preferably from 10 μm to 3 mm, particularly preferably from 20 μm to 1.5 mm, in particular from 100 μm to 400 μm.

The metallizable moldings can be subjected to further shaping processes conventional in plastics processing technology.

Composite Layered Sheets or Composite Layered Foils

The metallizable moldings of the invention in the form of foils or sheets can by way of example be processed to give metallizable composite layered sheets or metallizable composite layered foils.

Metallizable moldings in the form of foils or sheets are particularly suitable as outer layer (3) of multilayer composite layered sheets or of multilayer composite layered foils, where these have not only the outer layer but also at least one substrate layer (1) composed of thermoplastics. In further embodiments, the composite layered sheets or composite layered foils can comprise additional layers (2), such as color layers, adhesion-promoter layers, or intermediate layers, arranged between the outer layer (3) and the substrate layer (1).

The substrate layer (1) can in principle be composed of any thermoplastic. The substrate layer (1) is preferably produced from the following materials described above in the context of the thermoplastic molding compositions: impact-modified vinylaromatic copolymers, thermoplastic elastomers based on styrene, polyolefins, polycarbonates, and thermoplastic polyurethanes, or their mixtures, particularly preferably from ASA, ABS, SAN, polypropylene, and polycarbonate, or their mixtures.

Layer (2) differs from layers (1) and (3), for example by virtue of a polymer constitution differing from these and/or additive contents distinct from these, for example colorants or special-effect pigments. By way of example, layer (2) may be a coloring layer which preferably can comprise the following materials known to the person skilled in the art: dyes, color pigments, or special-effect pigments, such as mica or aluminum flakes. However, layer (2) may also serve to improve the mechanical stability of the composite layered sheets or composite layered foils, or serve to promote adhesion between the layers (1) and (3).

One embodiment of the invention provides a composite layered sheet or composite layered foil composed of a substrate layer (1) as described above, an outer layer (3), and, situated between these, an intermediate layer (2) which is composed of aliphatic thermoplastic polyurethane, of impact-modified polymethyl methacrylate (PMMA), of polycarbonate, or of styrene (co)polymers, such as SAN, which may have been impact-modified, examples being ASA or ABS, or mixtures of these polymers.

If aliphatic thermoplastic polyurethane is used as material of the intermediate layer (2), it is possible to use the aliphatic thermoplastic polyurethane described for layer (3).

If polycarbonate is used as intermediate layer (2), it is possible to use the polycarbonate described for layer (3).

Impact-modified PMMA (high-impact PMMA or HIPMMA) is a polymethyl methacrylate which has been rendered impact-resistant by virtue of suitable additives. Examples of suitable impact-modified PMMAs are described by M. Stickler, T. Rhein in Ullmann's encyclopedia of industrial chemistry Vol. A21, pages 473-486, VCH Publishers Weinheim, 1992, and H. Domininghaus, Die Kunststoffe and ihre Eigenschaften [Plastics and their properties], VDI-Verlag Düsseldorf, 1992.

The layer thickness of the above composite layered sheets or composite layered foils is generally from 15 to 5000 μm, preferably from 30 to 3000 μm, particularly preferably from 50 to 2000 μm.

In one preferred embodiment of the invention, the composite layered sheets or composite layered foils are composed of a substrate layer (1) and of an outer layer (3) with the following layer thicknesses: substrate layer (1) from 50 μm to 1.5 mm; outer layer (3) from 10 to 500 μm.

In another preferred embodiment of the invention, the composite layered sheets or composite layered foils are composed of a substrate layer (1), of an intermediate layer (2), and of an outer layer (3). Composite layered sheets or composite layered foils composed of a substrate layer (1), of an intermediate layer (2), and of an outer layer (3) preferably have the following layer thicknesses: substrate layer (1) from 50 μm to 1.5 mm; intermediate layer (2) from 50 to 500 μm; outer layer (3) from 10 to 500 μm.

The composite layered sheets or composite layered foils of the invention may also have, in addition to the layers mentioned, on that side of the substrate layer (1) facing away from the outer layer (3), other layers, preferably an adhesion-promoter layer, which serve for better adhesion of the composite layered sheets or composite layered foils with the backing layer which remains to be described below. Adhesion-promoter layers of this type are preferably produced from a material compatible with polyolefins, for example SEBS (styrene-ethylene-butadiene-styrene copolymer, e.g. marketed with the trademark Kraton®). If this type of adhesion-promoter layer is present, its thickness is preferably from 10 to 300 μm.

The composite layered sheets or composite layered foils may be produced by processes that are known and described in the prior art (for example in WO 04/00935), e.g. via adapter extrusion or coextrusion or mutual lamination or mutual laminating of the layers to one another. In the coextrusion processes, the components forming the individual layers are rendered flowable in extruders and, by way of specific apparatuses, are brought into contact with one another in such a way as to give the composite layered sheets or composite layered foils with the layer sequence described above. By way of example, the components can be coextruded through a slot die or a coextrusion die. EP-A2-0 225 500 explains this process.

They may also be produced by the adapter coextrusion process, as described in the proceedings of the extrusion technology conference “Coextrusion von Folien”, Oct. 8 and 9, 1996, VDI-Verlag Dusseldorf, in particular in the paper by Dr. Netze. Use is usually made of this cost-effective process whenever coextrusion is used.

The composite layered sheets and composite layered foils can also be produced via mutual lamination or mutual laminating of foils or sheets in a heatable nip. Here, foils or sheets are first produced separately, and these correspond to the layers described. Known processes can be used for this purpose. The desired layer sequence is then produced via appropriate mutual superposition of the foils or sheets, and these are then, by way of example, passed through a heatable nip between rolls, and are bonded with exposure to pressure and heat, to give a composite layered sheet or composite layered foil.

In particular in the adapter coextrusion process, balancing of the flow properties of the individual components is advantageous for formation of uniform layers in the composite layered sheets or composite layered foils.

Moldings Obtainable via Further Shaping Processes:

The metallizable foils or sheets or metallizable composite layered sheets or metallizable composite layered foils can be used for production of further moldings.

These processes can give any desired moldings, preferably sheet-like moldings, in particular of large surface area. These foils or sheets and composite layered sheets or composite layered foils are particularly preferably used for production of further moldings in which great importance is placed upon very good toughness values, good adhesion of the individual layers to one another, and good dimensional stability, thus by way of example minimizing damage via peeling of the surfaces. Particularly preferred moldings obtainable via further shaping processes have monofoils or composite layered sheets or composite layered foils and a backing layer composed of plastic applied to the back of the material by an injection-molding, foaming, casting, or compression-molding process.

Known processes, such as those described in WO 04/00935, can be used for production of these moldings from the metallizable foils or sheets or from the metallizable composite layered sheets or composite layered foils. (The processes for further processing of composite layered sheets or composite layered foils are described below, but these processes are also useful for the further processing of the foils or sheets). Material can be applied to the back of the composite layered sheets or composite layered foils by an injection-molding, foaming, casting or compression-molding process, without any other stage of processing. In particular, use of the composite layered sheets or composite layered foils described even permits production of slightly three-dimensional components without prior thermoforming. However, the composite layered sheets or composite layered foils may also be subjected to a prior thermoforming process.

By way of example, composite layered sheets or composite layered foils with the three-layer structure composed of backing layer, intermediate layer, and outer layer, or with the two-layer structure composed of backing layer and outer layer, can be thermoformed for production of relatively complex components. Either male-mold or female-mold thermoforming can be used here. Appropriate processes are known to the person skilled in the art. This thermoforming process orientates the composite layered sheets or composite layered foils. Since the surface quality and metallizability of the composite layered sheets or composite layered foils does not decrease at high orientation ratios, for example up to 1:5, there are almost no restrictions with respect to the possible orientation in the thermoforming process. After the thermoforming process, the composite layered sheets or composite layered foils can then be subjected to further shaping steps, for example profile-cuts.

The further metallizable moldings can be produced, if appropriate after the thermoforming processes described, by applying material to the back of the composite layered sheets or composite layered foils via injection-molding, foaming, casting, or compression-molding processes. These processes are known to the person skilled in the art and are described by way of example in DE-A1 100 55 190 or DE-A1 199 39 111.

The plastics materials applied in these injection-molding, compression-molding, or casting processes preferably comprise thermoplastic molding compositions based on ASA polymers or on ABS polymers, on SAN polymers, on poly(meth)acrylates, on polyether sulfones, on polybutylene terephthalate, on polycarbonates, on polypropylene (PP), or on polyethylene (PE), or else blends composed of ASA polymers or of ABS polymers and of polycarbonates or polybutylene terephthalate, and blends composed of polycarbonates and polybutylene terephthalate, and if PP and/or PE is used here it is clearly possible to provide the substrate layer in advance with an adhesion-promoter layer. Particularly suitable plastics materials are amorphous thermoplastics and their blends. A plastics material preferably used for application to the back of the material by an injection-molding process is ABS polymers or SAN polymers. In another preferred embodiment, thermoset molding compositions known to the person skilled in the art are used for application to the back of the material by a foaming or compression-molding process. In one preferred embodiment, these are glass-fiber-reinforced plastics materials, and suitable variants are in particular described in DE-A1 100 55 190. For application to the back of the material by a foaming process it is preferable to use polyurethane foams, for example those described in DE-A1 199 39 111.

In one preferred production process, the metallizable composite layered sheet or composite layered foil is thermoformed and then placed in an in-mold-coating mold, and thermoplastic molding compositions are applied to the back of the material by an injection-molding, casting, or compression-molding process, or thermoset molding compositions are applied to the back of the material by a foaming or compression-molding process.

After thermoforming and before placement into the in-mold-coating mold, the composite layered sheet or composite layered foil can undergo a profile-cut. The profile-cut can also be delayed until after removal from the in-mold-coating mold.

Dispersions

In another preferred embodiment, the substrates that can be used in the processes of the invention for the deposition of a metal by a chemical and/or electroplating method are those where, prior to the step of metallization by a chemical and/or electroplating method, the substrate is provided with a dispersion comprising exfoliated graphite and the dispersion is at least partially dried and/or at least partially hardened.

Preferred dispersions comprising exfoliated graphite comprise, based on the total weight of components A′, B′, and C′, which gives a total of 100% by weight,

a′ from 0.1 to 99.9% by weight, preferably from 2 to 89.5% by weight, particularly preferably from 4 to 84% by weight, of component A′,

b′ from 0.1 to 30% by weight, preferably from 0.5 to 20% by weight, particularly preferably from 1 to 10% by weight, of component B′, and

c′ from 0 to 99.8% by weight, preferably from 10 to 97.5% by weight, particularly preferably from 15 to 95% by weight, of component C′.

The dispersion can comprise, other than the components A′ to C′ mentioned, at least one of the following components:

d′ from 0.1 to 50% by weight, preferably from 0.5 to 40% by weight, particularly preferably from 1 to 20% by weight, based on the total weight of components A′-C′, of a dispersing agent component D′; and also

e′ from 0 to 50% by weight, preferably from 0.1 to 40% by weight, particularly preferably from 0.5 to 30% by weight, based on the total weight of components A′-C′, of a filler component E which differs from component B′.

The individual components of the dispersion are described below:

Component A′

The organic binder component A′ is a binder or binder mixture. Possible binders are binders having an anchor group that has pigment affinity, naturally occurring and synthetic polymers and their derivatives, naturally occurring resins and synthetic resins and their derivatives, natural rubber, synthetic rubber, proteins, cellulose derivatives, drying and non-drying oils, and the like. These can—but do not have to be—substances that cure chemically or physically, for example air-curing, radiation-curing, or heat-curing substances.

The binder component A′ is preferably a polymer or polymer mixture.

Polymers preferred as binder are ABS (acrylonitrile-butadiene-styrene); ASA (acrylonitrile-styrene-acrylate); acrylated acrylates; alkyd resins; alkylvinyl acetates; alkylene-vinyl acetate copolymers, in particular methylene-vinyl acetate, ethylene-vinyl acetate, butylene-vinyl acetate; alkylene-vinyl chloride copolymers; amino resins; aldehyde resins and ketone resins; cellulose and cellulose derivatives, in particular hydroxyalkylcellulose, cellulose esters, such as cellulose acetates, cellulose propionates, cellulose butyrates, carboxyalkylcelluloses, cellulose nitrate; epoxy acrylates; epoxy resins; modified epoxy resins, e.g. bifunctional or polyfunctional bisphenol A or bisphenol F resins, epoxy-novolak resins, brominated epoxy resins, cycloaliphatic epoxy resins; aliphatic epoxy resins, glycidic ethers, vinyl ethers, ethylene-acrylic acid copolymers; hydrocarbon resins; MABS (transparent ABS comprising acrylate units); melamine resins, maleic anhydride copolymers; methacrylates; natural rubber; synthetic rubber; chlorinated rubber; naturally occurring resins; rosins; shellac; phenolic resins; polyesters; polyester resins, such as phenyl ester resins; polysulfones; polyether sulfones; polyamides; polyimides; polyanilines; polypyrroles; polybutylene terephthalate (PBT); polycarbonate (e.g. Makrolon® from Bayer AG); polyester acrylates; polyether acrylates; polyethylene; polyethylene-thiophenes; polyethylene naphthalates; polyethylene terephthalate (PET); polyethylene terephthalate glycol (PETG); polypropylene; polymethyl methacrylate (PMMA); polyphenylene oxide (PPO); polystyrenes (PS), polytetrafluoroethylene (PTFE); polytetrahydrofuran; polyethers (e.g. polyethylene glycol, polypropylene glycol), polyvinyl compounds, in particular polyvinyl chloride (PVC), PVC copolymers, PVdC, polyvinyl acetate, and also copolymers of these, polyvinyl alcohol, if appropriate in partially hydrolyzed form, polyvinyl acetals, polyvinyl acetates, polyvinylpyrrolidone, polyvinyl ethers, polyvinyl acrylates and polyvinyl methacrylates in solution and in the form of a dispersion, and also copolymers of these, polyacrylates and polystyrene copolymers; polystyrene (impact-modified or non-impact-modified); polyurethanes, non-crosslinked or crosslinked with isocyanates; polyurethane acrylates, styrenic-acrylic copolymers; styrene-butadiene block copolymers (e.g. Styroflex® or Styrolux® from BASF AG, K-Resin™ from CPC, Kraton D or Kraton G from Kraton Polymers); proteins, e.g. casein; SIS; triazine resin, bismaleimide-triazine resin (BT), cyanate ester resin (CE), allylated polyphenylene ethers (APPE).

Mixtures of two or more polymers may also form the organic binder component A′.

Polymers preferred as component A′ are acrylates, acrylate resins, cellulose derivatives, methacrylates, methacrylate resins, melamine, and amino resins, polyalkylenes, polyimides, epoxy resins, modified epoxy resins, e.g. bifunctional or polyfunctional bisphenol A or bisphenol F resins, epoxy-novolak resins, brominated epoxy resins, cycloaliphatic epoxy resins; aliphatic epoxy resins, glycidic ethers, vinyl ethers, and phenolic resins, polyurethanes, polyesters, polyvinyl acetals, polyvinyl acetates, polystyrenes, polystyrene copolymers, polystyrene-acrylates, styrene-butadiene block copolymers, alkylene-vinyl acetates, and vinyl chloride copolymers, polyam ides, and also copolymers of these.

Component B′

Materials that can be used as component B′ are the exfoliated graphite particles described as component B above.

In one embodiment of the invention, the method of addition of the graphite particles to the dispersion is that the graphite particles are first incorporated into binder component A′; if component A′ involves a polymer or a polymer mixture, this incorporation can take place during or after the polymerization of the monomers to give binder component A′. If the graphite particles are added after the polymerization reaction, they is preferably added via addition to the polymer melt in an extruder or preferably in a kneader. The compounding procedure in the kneader or extruder can substantially or indeed completely comminute aggregates of graphite particles, and can disperse the graphite particles in the polymer matrix.

In one preferred embodiment of the prior incorporation of the graphite particles into binder component A′, the graphite particles can be fed in the form of highly concentrated masterbatches in polymers preferably selected from the group of the polymers used as component A′. The concentration of the graphite particles in the masterbatches is usually in the range from 5 to 50% by weight, preferably from 8 to 30% by weight, particularly preferably in the range from 12 to 22% by weight. The production of masterbatches is described by way of example in U.S. Pat. No. 5,643,502. Use of masterbatches can in particular improve the comminution of the aggregates.

The process of incorporation into the dispersion, or the prior incorporation into component A′, can cause the length distributions of the graphite particles to be shorter than those initially used.

Component C′

The dispersion moreover comprises a solvent component C′. This is composed of a solvent or of a solvent mixture.

Examples of suitable solvents are aliphatic and aromatic hydrocarbons (e.g. n-octane, cyclohexane, toluene, xylene), alcohols (e.g. methanol, ethanol, 1-propanol, 2-propanol, 1-butanol, 2-butanol, amyl alcohol), polyhydric alcohols, such as glycerol, ethylene glycol, propylene glycol, neopentyl glycol, alkyl esters (e.g. methyl acetate, ethyl acetate, propyl acetate, butyl acetate, isobutyl acetate, isopropyl acetate, 3-methylbutanol), alkoxyalcohols (e.g. methoxypropanol, methoxybutanol, ethoxypropanol), alkylbenzenes (e.g. ethylbenzene, isopropylbenzene), butyl glycol, butyl diglycol, alkyl glycol acetates (e.g. butyl glycol acetate, butyl diglycol acetate), diacetone alcohol, diglycol dialkyl ethers, diglycol monoalkyl ethers, dipropylene diglycol dialkyl ethers, dipropylene glycol monoalkyl ethers, diglycol alkyl ether acetates, dipropylene glycol alkyl ether acetates, dioxane, dipropylene glycol and dipropylene glycol ethers, diethylene glycol and diethylene glycol ethers, DBE (dibasic esters), ethers (e.g. diethyl ether, tetrahydrofuran), ethylene chloride, ethylene glycol, ethylene glycol acetate, ethylene glycol dimethyl ether, cresol, lactones (e.g. butyrolactone), ketones (e.g. acetone, 2-butanone, cyclohexanone, methyl ethyl ketone (MEK), methyl isobutyl ketone (MIBK), methyl diglycol, methylene chloride, methylene glycol, methylglycol acetate, methylphenol (ortho-, meta-, para-cresol), pyrrolidones (e.g. N-methyl-2-pyrrolidone), propylene glycol, propylene carbonate, carbon tetrachloride, toluene, trimethylolpropane (TMP), aromatic hydrocarbons and mixtures, aliphatic hydrocarbons and mixtures, alcoholic monoterpenes (e.g. terpineol), water, and also mixtures composed of two or more of these solvents.

Preferred solvents are alcohols (e.g. ethanol, 1-propanol, 2-propanol, butanol), alkoxy alcohols (e.g. methoxypropanol, ethoxypropanol, butylglycol, butyldiglycol), butyrolactone, diglycol dialkyl ethers, diglycol monoalkyl ethers, dipropylene glycol dialkyl ethers, dipropylene glycol monoalkyl ethers, esters (e.g. ethyl acetate, butyl acetate, butylglycol acetate, butyldiglycol acetate, diglycol alkyl ether acetates, dipropylene glycol alkyl ether acetates, DBE), ethers (e.g. tetrahydrofuran), polyhydric alcohols, such as glycerol, ethylene glycol, propylene glycol, neopentyl glycol, ketones (e.g. acetone, methyl ethyl ketone, methyl isobutyl ketone, cyclohexanone), hydrocarbons (e.g. cyclohexane, ethylbenzene, toluene, xylene), N-methyl-2-pyrrolidone, water, and also mixtures of these.

Component D′

The dispersion can moreover comprise, as dispersing agent component D′, the dispersing agent described above as component C.

Component E′

The dispersion can moreover comprise, as filler component E′, the fillers described above as component D.

The dispersions can moreover comprise, alongside the components mentioned A′, B′, C′, and, if appropriate, D′ and/or E′, further added materials, such as processing aids and stabilizers, e.g. UV stabilizers, lubricants, corrosion inhibitors, and flame retardants.

It is also possible to use further additives, such as agents with thixotropic effect, e.g. silica, silicates, e.g. aerosils or bentonites, or organic agents with thixotropic effect and thickeners, e.g. polyacrylic acid, polyurethanes, hydrogenated castor oil, dyes, fatty acids, fatty acid amides, plasticizers, wetting agents, antifoams, lubricants, desiccants, crosslinking agents, photoinitiators, complexing agents, waxes, pigments, and conductive polymer particles.

The content of further added materials, based on the total weight of the dispersion, is usually from 0.01 to 30% by weight. The content is preferably from 0.1 to 10% by weight.

Preferred processes for the production of the dispersion comprise the following steps:

a′) mixing of components A′ to B′ (or, respectively, A to C) and at least a portion of component C′ (or, respectively, D), and also, if appropriate, of D′, and E′ (or, respectively, E, F), and of further components,

b′) dispersion of the mixture,

c′) if appropriate, addition of the proportion not used in step a′) of component C′ (or, respectively, D) to adjust the viscosity for the respective application process.

The dispersion can be produced by intensive mixing and dispersion using assemblies known to persons skilled in the art. This includes the mixing of the components in an intensive-dispersion assembly, e.g. kneader, ball mills, bead mills, dissolver, three-roll mill, or rotor-stator mixer.

It is possible to mix all of the desired components of the dispersion in one processing step. However, it is also possible to mix two or more components in advance, for example components A′ and B′ as described above, and to delay admixture of the remaining components until a subsequent separate processing step has been reached.

One embodiment of the processes of the invention for the production of a metal layer of at least one portion of the surface of a substrate comprises the following steps:

a) application, to the substrate, of a dispersion comprising exfoliated graphite;

b) at least partial drying and/or at least partial hardening of the applied layer on the substrate; and

c) deposition of a metal by a chemical and/or electroplating method on the at least partially dried and/or at least partially hardened dispersion layer.

In the process of application of the dispersion and for adjustment of the viscosity in step a), it is preferable that the dispersion is stirred and that its temperature is controlled.

If appropriate, an activation step can also be inserted between steps b) and c). This is composed of at least partial exposure of the electrically conductive particles via at least partial chemical and/or mechanical disruption of the dried and/or hardened dispersion layer.

If the electrically conductive particles comprise a material which is readily susceptible to oxidation, it is possible in one variant of the process, prior to formation of the metal layer on the structured or flat dried and/or hardened dispersion layer, to remove at least partially the oxide layer of the electrically conductive particles. By way of example, chemical and/or mechanical means can be used here for the removal of the oxide layer. Suitable substances which can be used to treat the dried and/or hardened dispersion layer for chemical removal of an oxide layer from the electrically conductive particles are acids, such as concentrated or dilute sulfuric acid, or concentrated or dilute hydrochloric acid, citric acid, phosphoric acid, amidosulfonic acid, formic acid, or acetic acid.

The at least partial removal of the oxide layer, and also the at least partial exposure of the electrically conductive particles at the surface, can also take place in the same operation.

A suitable substrate is provided by electrically non-conductive materials, such as polymers. Suitable polymers are epoxy resins, e.g. bifunctional or polyfunctional, aramid-reinforced or glass fiber-reinforced or paper-reinforced epoxy resins (e.g. FR4), glass fiber-reinforced plastics, liquid-crystal polymers (LCP), polyphenylene sulfides (PPS), polyoxymethylenes (POM), polyaryl ether ketones (PAEK), polyether ether ketones (PEEK), polyam ides (PA), polycarbonates (PC), polybutylene terephthalates (PBT), polyethylene terephthalates (PET), polyimides (PI), polyimide resins, cyanate esters, bismaleimide-triazine resins, nylon, vinyl ester resins, polyesters, polyester resins, polyamides, polyanilines, phenolic resins, polypyrroles, polynaphthalene terephthalates, polymethyl methacrylate, polyethylenedioxythiophenes, phenolic-resin-coated aramid paper, polytetrafluoroethylene (PTFE), melamine resins, silicone resins, fluoro resins, dielectrics, APPE, polyetherimides (PEI), polyphenylene oxides (PPO), polypropylenes (PP), polyethylenes (PE), polysulfones (PSU), polyether sulfones (PES), polyarylamides (PAA), polyvinyl chlorides (PVC), polystyrenes (PS), acrylonitrile-butadiene-styrenes (ABS), acrylonitrile-styrene-acrylates (ASA), styrene-acrylonitriles (SAN), and also mixtures (blends) of two or more of the abovementioned polymers, which may take a very wide variety of forms. The substrates can comprise additives known to the person skilled in the art, e.g. flame retardants.

In principle, it is also possible to use any of the polymers listed under component A′.

Other suitable substrates are composite materials, foam-type polymers, Styropor®, Styrodur®, polyurethanes (PU), ceramic surfaces, textiles, cardboard, paperboard, paper, polymer-coated paper, wood, mineral materials, silicon, glass, plant tissue, or else animal tissue, or resin-saturated woven fabrics, pressed to give sheets or rolls.

For the purposes of this embodiment of the present invention, an “non-electrically-conductive substrate” preferably means that the surface resistance of the substrate is more than 10⁹ ohms/cm.

The dispersion can be applied to the substrate/backing by methods known to the person skilled in the art.

Application to the substrate surface can take place on one or more sides and can extend over one, two, or three dimensions. The substrate can generally have any desired geometry appropriate for the intended purpose.

The dispersion can be applied in structured or non-structured form in step a). It is preferable that the steps of application [step a)], of drying and/or hardening [step b)], and the deposition of a metal [step c)] are carried out in a continuous procedure. This is possible by virtue of the simple conduct of steps a), b), and c). However, a batchwise or semi-continuous process is, of course, possible.

The coating method used can involve the conventional and well-known coating processes (casting, spreading, doctoring, brushing, printing (intaglio print, screenprint, flexographic print, pad print, inkjet, offset, the LaserSonic® process, as described in DE10051850, etc.), spraying, dip-coating, rolling, powdering, fluidized bed, or the like). The layer thickness preferably varies from 0.01 to 100 μm, more preferably from 0.1 to 50 μm, particularly preferably from 1 to 25 μm. The layers can be applied in a non-structured or structured manner.

Conventional methods are used for the drying or hardening of the coating applied in structured or non-structured form. For example, the dispersion can be hardened by a chemical route, e.g. via a polymerization, polyaddition or polycondensation reaction of the binder, for example via UV radiation, electron beam, microwave radiation, IR radiation, or heat, or by a purely physical route via evaporation of the solvent. It is also possible to combine drying by a physical and chemical route.

The layer obtained after application of the dispersion and at least partial drying and/or at least partial hardening permits subsequent deposition of a metal by a chemical and/or electroplating method on the at least partially dried and/or at least partially hardened dispersion layer.

Metal Deposition on Substrate by a Currentless or Electroplating Method

The substrate whose surface comprises exfoliated graphite, for example the graphite-containing thermoplastic molding compositions, or the substrates coated with graphite-containing dispersions, are particularly suitable for the deposition of metal layers by an electroplating method, i.e. for the production of metallized substrates, without any need for complicated pretreatment of the substrate surface.

In principle, any of the processes known to the person skilled in the art and described in the literature for deposition of metals by a currentless or electroplating method on plastics surfaces is suitable as process for production of the metallized substrates. (see, for example, Harold Ebneth et al., Metallisieren von Kunststoffen: Praktische Erfahrungen mit physikalisch, chemisch und galvanisch metallisierten Hochpolymeren [Metallization of plastics: practical experience with high polymers metallized by physical, chemical, and electroplating methods], Expert Verlag, Renningen-Malmsheim, 1995, ISBN 3-8169-1037-8; Kurt Heymann et al., Kunststoffmetallisierung: Handbuch für Theorie und Praxis [Metallization of plastics: theoretical and practical manual] No. 22 in the series of publications entitled Galvanotechnik und Oberflächenbehandlung [Electroplating technology and surface treatment], Saulgau: Leuze, 1991; Mittal, K. L. (ed.), Metallized Plastics Three: Fundamental and Applied Aspects, Third Electrochemical Society Symposium on Metallized Plastics: Proceedings, Phoenix, Arizona, Oct. 13-18, 1991, New York, Plenum Press).

It is preferable that, after the respective final shaping process, the metallizable substrates are arranged as cathodes via application of an electrical potential and brought into contact with an acidic, neutral, or basic metal salt solution, whereupon the metal of this metal salt solution is deposited by an electroplating method on the surface comprising the graphite particles in the metallizable substrates. Preferred metals for deposition are chromium, nickel, copper, gold, and silver, in particular copper. It is also possible to deposit a plurality of metal layers in succession by an electroplating method, for example by introducing the metallizable substrates into dip-coating baths with solutions of different metals, in each case with application of external voltage and flow of current. In the case of currentless deposition, the metal should be nobler than the electrically conductive particles (C).

Although no particular pretreatment of the surface of the metallizable substrates is needed prior to currentless metallization by a chemical and/or electroplating method, it is possible in principle to carry out surface activation by processes known to the person skilled in the art. Surface activation of the substrate surface can be used to improve adhesion or else to accelerate metal deposition, by roughening the surface in a controlled manner or using a controlled method to expose graphite particles at the surface. Exposure of the graphite particles also has the advantage that a smaller proportion can be used in the polymer matrix to achieve metallization.

The surface activation can by way of example be achieved via mechanical abrasion, in particular via brushing, grinding, or polishing with an abrasive, or impact under pressure from a water jet, or sandblasting, or blasting with supercritical carbon dioxide (dry ice), or by physical methods, e.g. via heating, laser, UV light, corona or plasma discharge, and/or chemical abrasion, in particular via etching and/or oxidation. Processes for carrying out mechanical abrasion and/or chemical abrasion are known to the person skilled in the art and are described in the prior art.

The abrasive used for polishing can be any of the abrasives known to the person skilled in the art. An example of a suitable abrasive is pumice flour. In order to ablate the uppermost layer of the hardened dispersion when using a water jet under pressure, the water jet preferably comprises small solid grains, such as pumice flour (Al₂O₃) whose average grain size distribution is from 40 to 120 μm, preferably from 60 to 80 μm, or else powdered quartz (SiO₂) whose grain size is >3 μm.

Surface activation can also take place via stretching (also often termed drawing or elongation) of the metallizable substrate, in particular by a factor of from 1.1 to 10, preferably from 1.2 to 5, particularly preferably from 1.3 to 3.

The embodiments mentioned of mechanical and/or chemical abrasion and of stretching can, of course, also be applied in combination with one another for surface activation.

The stretching can take place in one or more directions. In the case of extruded profiles, strands, or tubes, stretching preferably takes place in one direction, and in the case of sheet-like plastics articles it is preferable that multidirectional, in particular bidirectional, stretching takes place, for example in the blow-molding or thermoforming process on foils or sheets. In the case of multidirectional stretching, it is essential that the stretching factor mentioned is achieved in at least one direction of stretching.

Processes that can be used for stretching are in principle any of the stretching processes described in the literature and known to the person skilled in the art. Examples of preferred stretching processes for foils are blow-molding processes.

In the case of chemical abrasion, it is preferable to use a chemical or mixture of chemicals appropriate for the polymer of the substrate. In the case of chemical abrasion, the polymer can, for example, be at least partially dissolved away at the surface by a solvent, or the chemical structure of the matrix material can be at least to some extent disrupted by means of suitable reagents, thus exposing the graphite particles. Reagents which swell the matrix material are also suitable for exposing the graphite particles. The swelling produces cavities in which the metal ions to be deposited can penetrate from the electrolyte solution, thus permitting metallization of a larger proportion of graphite. The higher proportion of exposed graphite particles leads to a higher processing speed during metallization.

If the matrix material is, for example, an epoxy resin, a modified epoxy resin, an epoxy-novolak, a polyacrylate, ABS, a styrene-butadiene copolymer, or a polyether, release of the graphite particles is preferably achieved by an oxidant. The oxidant breaks bonds of the matrix material, thus permitting break-away of the binder with resultant release of the particles. Examples of suitable oxidants are manganates, e.g. potassium permanganate, potassium manganate, sodium permanganate, sodium manganate, hydrogen peroxide, oxygen, oxygen in the presence of catalysts, e.g. salts of manganese, of molybdenum, of bismuth, of tungsten, and of cobalt, ozone, vanadium pentoxide, selenium dioxide, ammonium polysulfide solution, sulfur in the presence of ammonia or of amines, manganese dioxide, potassium ferrate, dichromate/sulfuric acid, chromic acid in sulfuric acid or in acetic acid or in acetic anhydride, nitric acid, hydroiodic acid, hydrobromic acid, pyridinium dichromate, chromic acid-pyridine complex, chromic anhydride, chromium(VI) oxide, periodic acid, lead tetraacetate, quinone, methylquinone, anthraquinone, bromine, chlorine, fluorine, ferric salt solutions, disulfate solutions, sodium percarbonate, salts of oxohalic acids, e.g. chlorates or bromates or iodates, salts of perhalo acids, e.g. sodium periodate or sodium perchlorate, sodium perborate, dichromates, e.g. sodium dichromate, salts of persulfuric acid, such as potassium peroxodisulfate, potassium peroxomonosulfate, pyridinium chlorochromate, salts of hypohalic acids, e.g. sodium hypochlorite, dimethyl sulfoxide in the presence of electrophilic reagents, tert-butyl hydroperoxide, 3-chloroperbenzoic acid, 2,2-dimethylpropanal, Des-Martin-periodinane, oxalyl chloride, urea-hydrogen peroxide adduct, urea peroxide, 2-iodoxybenzoic acid, potassium peroxomonosulfate, m-chloroperbenzoic acid, N-methylmorpholine N-oxide, 2-methylprop-2-yl hydroperoxide, peracetic acid, pivaldehyde, osmium tetraoxide, oxones, ruthenium(III) salts and ruthenium(IV) salts, oxygen in the presence of 2,2,6,6-tetramethylpiperidinyl N-oxide, triacetoxyperiodinane, trifluoroperacetic acid, trimethylacetaldehyde, ammonium nitrate. The temperature can optionally be increased during the process in order to improve the release process.

Preference is given to manganates, such as potassium permanganate, potassium manganate, sodium permanganate; sodium manganate, hydrogen peroxide, N-methyl-morpholine N-oxide, percarbonates, e.g. sodium percarbonate or potassium percarbonate, perborates, e.g. sodium perborate or potassium perborate; persulfates, such as sodium persulfate or potassium persulfate; the peroxodi- and -monosulfates of sodium, of potassium, and of ammonium, sodium hypochlorite, urea-hydrogen peroxide adducts, salts of oxohalic acids, such as chlorates or bromates or iodates, salts of perhalic acids, such as sodium periodate or sodium perchlorate, tetrabutylammonium peroxydisulfate, quinones, ferric salt solutions, vanadium pentoxide, pyridinium dichromate, hydrochloric acid, bromine, chlorine, dichromates.

Particular preference is given to potassium permanganate, potassium manganate, sodium permanganate, sodium manganate, hydrogen peroxide and its adducts, perborates, percarbonates, persulfates, peroxodisulfates, sodium hypochloride, and perchlorates.

For exposure of the graphite particles in a matrix material which comprises, for example, ester structures, e.g. polyester resins, polyester acrylates, polyether acrylates, polyester urethanes, it is preferable to use, for example, acidic or alkaline chemicals and/or mixtures of chemicals. Preferred acidic chemicals and/or mixtures of chemicals are, for example, concentrated or dilute acids, such as hydrochloric acid, sulfuric acid, phosphoric acid, or nitric acid. Organic acids can also be suitable as a function of the matrix material, examples being formic acid or acetic acid. Suitable alkaline chemicals and/or mixtures of chemicals are, for example, bases, such as sodium hydroxide solution, potassium hydroxide solution, ammonium hydroxide, or carbonates, such as sodium carbonate or potassium carbonate. The temperature can optionally be increased during the process in order to improve the release process.

Solvents can also be used for exposure of the graphite particles in the matrix material. The solvent has to be appropriately matched to the matrix material, since the matrix material must undergo dissolution in the solvent or solvation by the solvent. If a solvent in which the matrix material is soluble is used, the base layer is brought into contact with the solvent for only a short time, in order that the upper layer of the matrix material is solvated and thus separated. In principle, any of the abovementioned solvents can be used. Preferred solvents are xylene, toluene, halogenated hydrocarbons, acetone, methyl ethyl ketone (MEK), methyl isobutyl ketone (MIBK), diethylene glycol monobutyl ether. To improve solvent behavior, the temperature can optionally be increased during the dissolution procedure.

The thicknesses of the one or more metal layers deposited by a chemical and/or electroplating method are within the conventional range known to the person skilled in the art and are not significant for the invention.

Particularly preferred metallized substrates for use as electrically conducting components, in particular printed circuit boards, have at least one metal layer deposited by a chemical and/or electroplating method, in particular a copper layer, silver layer, or gold layer.

Particularly preferred metallized substrates for use in the decorative sector have a copper layer deposited by a chemical and/or electroplating method, and a nickel layer thereupon deposited by a chemical and/or electroplating method, and a chromium layer, silver layer, or gold layer deposited thereupon.

The metallized substrates, if appropriate after production of conductor track structures by the processes described in the literature and known to the person skilled in the art, are suitable as electrically conducting components, in particular printed circuit boards, RFID antennas, transponder antennas, or other antenna structures, switches, sensors, and MIDs, EMI shielding materials (i.e. shielding to avoid electromagnetic interference), such as absorbers, attenuators, or reflectors for electromagnetic radiation, or as gas barriers or decorative parts, in particular decorative parts in the motor vehicle sector, sanitary sector, toy sector, household sector, and office sector.

Examples of these applications are: computer cases, cases for electronic components, military and non-military shielding devices, shower fittings and washstand fittings, shower heads, shower rails, shower holders, metallized door handles and door knobs, toilet-paper-roll holders, bathtub grips, metallized decorative strips on furniture and on mirrors, and frames for shower partitions.

Mention may also be made of: metallized plastics surfaces in the automotive sector, e.g. decorative strips, exterior mirrors, radiator grilles, front end metallization, aerofoil surfaces, exterior bodywork parts, door sills, replacement tread plate, decorative wheel covers.

Parts that can be produced from plastic are particularly those which hitherto have been produced partially or entirely from metals. Examples that may be mentioned here are: tools, such as pliers, screwdrivers, drills, drill chucks, saw blades, ring wrenches, and open-jaw wrenches.

The metallized substrates—insofar as they comprise magnetizable metals—are also used in the sectors of magnetizable functional parts, e.g. magnetic panels, magnetic games, magnetic surfaces in, for example, refrigerator doors. They are also applied in sectors where good thermal conductivity is advantageous, for example in foils for seat-heating systems, floor covering-heating systems, insulation materials.

The present invention also provides a substrate surface with an at least partial electrically conductive metal layer obtainable by the process of the invention described above for the production of a metal layer.

This type of substrate surface can be used for conducting electrical current or heat, for shielding from electromagnetic radiation, or else for magnetization.

The present invention also provides the use of a dispersion of the invention for the application of a metal layer.

The substrate surface of the invention, and also the process of the invention, can in particular be used for various applications listed below.

The substrate surface of the invention and/or the process of the invention are suitable by way of example for the production of conductor tracks on printed circuit boards. Examples of these printed circuit boards are those with multilayer internal and external sublayers, microvias, chip-on-board, flexible and rigid printed circuit boards, these being, for example, installed in products such as computers, telephones, televisions, electrical automobile components, keyboards, radios, video players, CD players, CD-ROM players, and DVD players, games consoles, measurement devices and control devices, sensors, electrical kitchen machines, electrical toys, etc.

The process of the invention can also be used to coat electrically conductive structures on flexible backings of circuits. These flexible backings of circuits are, for example, plastics foils composed of the abovementioned backing materials, on which electrically conductive structures have been printed. The inventive process is also suitable for production of RFID antennas, of transponder antennas, or of antenna structures, of chip card modules, of ribbon cables, of seat-heating systems, of foil conductors, of conductor tracks in solar cells or in LCD display screens or in plasma display screens, or of foil capacitors or other capacitors, of resistances, of convectors, or of electrical fuses, or for production of products in any desired form coated by an electroplating process, examples being mono- or bilaterally metal-coated polymer substrates with defined layer thickness, or 3D-molded interconnect devices, or else for production of decorative or functional surfaces on products used, for example, for shielding from electromagnetic radiation, or for conducting heat, or on products used as packaging.

It is also possible to produce antennas with contacts for organic electronic components, or else to produce coatings on surfaces of non-electrically-conductive material, for electromagnetic shielding (EMI) purposes.

It is also possible to produce a metallic inner coating for production of waveguides for high-frequency signals with a structure composed of non-electrically-conductive material to provide mechanical support. The substrate surface can also be a part of foil capacitors.

Another possible use is in the sector of flowfields of bipolar plates for fuel-cell applications.

It is also possible to produce a non-structured or structured electrically conductive layer for the subsequent decorative metallization of moldings, composed of the abovementioned non-electrically-conductive substrate.

The scope of application of the process of the invention for the production of a metal layer with the aid of the dispersion of the invention and also of the substrate surface of the invention permits low-cost production of metallized substrates where the substrates are themselves not conductive, in particular for use as switches and sensors, absorbers for electromagnetic radiation, or gas barriers, or decorative parts, in particular decorative parts for the motor vehicle sector, sanitary sector, toy sector, household sector, and office sector, and packaging, and also foils. The invention can also be used in the sector of security printing for banknotes, credit cards, personal identification papers, etc. The process of the invention can be used for electrical and magnetic functionalization of textiles (transmitters, RFID antennas, transponder antennas and other antennas, and sensors, heating elements, antistatic systems (including those for plastics), shielding systems, etc.).

It is also possible to use non-conductive material to produce parts which hitherto have been produced in part or entirely from metals. By way of example, mention may be made here of downpipes, gutters, doors, and also window frames.

It is also possible to produce contact sites or contact pads or wiring on an integrated electrical module.

It is also possible to produce thin metal foils or mono- or bilaterally laminated polymer backing materials, or metallized plastics surfaces, e.g. decorative strips or exterior mirrors.

The dispersion of the invention and/or the process can likewise be used for the metallization of holes, including blind holes, and of vias, etc., for example in printed circuit boards, in RFID antennas, in transponder antennas, in ribbon cables, or in foil conductors, with the aim of establishing contact through the upper or lower side. This also applies when other substrates are used.

Preferred uses of the substrate surface metallized in the invention are those where the resultant substrate serves as conductor track, RFID antenna, transponder antenna, seat-heating system, ribbon cable, contactless chip cards, thin metal foils, or mono- or bilaterally laminated polymer backings, foil conductors, conductor tracks in solar cells or in LCD display screens or in plasma display screens, or as decorative application, e.g. for packaging materials.

The dispersions and processes of the invention are of substantial importance for the provision of optimized systems for the metallic coating of non-electrically-conducting substrates, in particular with use of conductive lacquers or of conductive dispersions, where these have, when compared with known systems, an improved combination of properties composed of low weight, good adhesion, dispersibility, and flowability, and high electrical conductivity. It is moreover possible to use the dispersion and the process of the invention to produce homogeneous and continuous metal layers on non-electrically-conductive materials.

After coating by a currentless and/or electroplating method, the substrate can be further processed by using any of the steps known to the person skilled in the art. By way of example, electrolyte residues present can be removed from the substrate by rinsing, and/or the substrate can be dried.

The processes of the invention permit improved application of a metal layer on a substrate via deposition of a metal from a metal salt solution by a chemical and/or electroplating method. In particular, metal layers with good adhesion to the substrate can be deposited on a substrate by the processes of the invention within comparatively short electroplating times at low cost and with good quality. The resultant metallized substrates have comparatively low weight.

1.-25. (canceled)

26. A process for the application of a metal layer on a substrate by deposition of a metal from a metal salt solution, which comprises the presence of exfoliated graphite in the substrate surface.

27. The process according to claim 26, wherein the surface area of the exfoliated graphite is from 300 to 2600 m²/g.

28. The process according to claim 26, wherein the substrate comprises a thermoplastic molding composition, where the thermoplastic molding composition comprises, based on the total weight of components A, B, C, and D, which gives a total of 100% by weight,
a from 20 to 99% by weight of a thermoplastic polymer as component A,
b from 1 to 30% by weight of exfoliated graphite as component B,
c from 0 to 10% by weight of a dispersing agent as component C, and
d from 0 to 40% by weight of fibrous or particulate fillers, or a mixture of these, as component D,
or, based on the total weight of components A, B, C, D, and E, which gives a total of 100% by weight,
a from 20 to 98% by weight of a thermoplastic polymer as component A,
b from 1 to 30% by weight of exfoliated graphite as component B,
c from 1 to 70% by weight of electrically conductive particles whose average particle diameter is from 0.01 to 100 μm as component C,
d from 0 to 10% by weight of a dispersing agent as component D, and
e from 0 to 40% by weight of fibrous or particulate fillers, or a mixture of these, as component E.

29. The process according to claim 28, wherein the component A used comprises one or more polymers selected from the group of impact-modified vinylaromatic copolymers, of thermoplastic elastomers based on styrene, of polyolefins, of polycarbonates, of polyamides, of polyvinyl chloride, of polyesters, of epoxy resins, and of thermoplastic polyurethanes, and also of mixtures of these.

30. The process according to claim 26, wherein the substrate is provided with a dispersion, and the dispersion is at least partially dried and/or at least partially hardened, and after the at least partial drying and/or at least partial hardening of the dispersion, deposition of the metal takes place by a chemical and/or electroplating method, and the dispersion here comprises
a′ from 0.1 to 99.9% by weight, based on the total weight of components A′, B′, and C′, of an organic binder component A′,
b′ from 0.1 to 30% by weight, based on the total weight of components A′, B′, and C′, of exfoliated graphite as component B′,
c′ from 0 to 99.8% by weight, based on the total weight of components A′, B′, and C′, of a solvent component C′
and moreover, if appropriate, at least one of the following components:
d′ from 0.1 to 50% by weight, based on the total weight of components A′, B′, and C′, of a dispersing agent component D′, and also e′ from 0.1 to 50% by weight, based on the total weight of components A′, B′, and C′, of a filler component E′
or
a from 0.1 to 99.8% by weight, based on the total weight of components A, B, C, and D, of an organic binder component A
b from 0.1 to 30% by weight, based on the total weight of components A, B, C, and D, of exfoliated graphite as component B,
c from 0.1 to 70% by weight, based on the total weight of components A, B, C, and D, of electrically conductive particles whose average particle diameter is from 0.01 to 100 μm as component C,
d from 0 to 99.7% by weight, based on the total weight of components A, B, C, and D, of a solvent component D, and moreover, if appropriate, at least one of the following components:
e from 0.1 to 20% by weight, based on the total weight of components A, B, C, and D, of a dispersing agent component E, and also
f from 0.1 to 40% by weight, based on the total weight of components A, B, C, and D, of an additive F.

31. The process according to claim 30, wherein the binder component A′ is composed of a polymer or polymer mixture.

32. The process according to claim 30, wherein the dispersion is applied in structured or non-structured form to the substrate.

33. The process according to claim 26, wherein the substrate surface comprising exfoliated graphite is surface-activated before a chemical and/or electroplating method is used for deposition of a metal.

34. A substrate surface at least partially comprising an electrically conductive metal layer obtainable from the processes according to claim 26.

35. A thermoplastic molding composition for the production of moldings that can be metallized by a currentless and/or electroplating method, comprising, based on the total weight of components A, B, C, D, and E, which gives a total of 100% by weight,
a from 20 to 98% by weight of a thermoplastic polymer as component A,
b from 1 to 30% by weight of exfoliated graphite as component B,
c from 1 to 70% by weight of electrically conductive particles whose average particle diameter is from 0.01 to 100 μm as component C,
d from 0 to 10% by weight of a dispersing agent as component D, and
e from 0 to 40% by weight of fibrous or particulate fillers, or a mixture of these, as component E.

36. The thermoplastic molding composition according to claim 35, wherein the component C used comprises metal powder.

37. A process for the production of moldings metallized by a currentless and/or electroplating method, which comprises mixing the thermoplastic molding compositions according to claim 35 in the melt, and then extruding or injection-molding them, and then, if appropriate, carrying out one or more further shaping processes, and finally depositing a metal layer from a metal salt solution by a currentless and/or electroplating method, where if appropriate prior to the metal deposition by a currentless and/or electroplating method a surface of the thermoplastic molding compositions is activated.

38. A metallized molding produced, by a process according to claim 37.

39. The metallized molding according to claim 38, comprising one or more metal layers composed of copper and/or chrome and/or nickel.

40. An electrically conducting component, EMI shielding unit, such as an absorber, attenuator, or reflector for electromagnetic radiation, a gas barrier, or a decorative part, in particular a decorative part in the motor vehicle sector, sanitary sector, toy sector, household sector, or office sector, comprising metallized moldings according to claim 38.

41. A dispersion for the application of a metal layer on a non-electrically-conductive substrate, comprising
a from 0.1 to 99.8% by weight, based on the total weight of components A, B, C, and D, of an organic binder component A,
b from 0.1 to 30% by weight, based on the total weight of components A, B, C, and D, of exfoliated graphite as component B,
c from 0.1 to 70% by weight, based on the total weight of components A, B, C, and D, of electrically conductive particles whose average particle diameter is from 0.01 to 100 μm as component C,
d from 0 to 99.7% by weight, based on the total weight of components A, B, C, and D, of a solvent component D, and moreover, if appropriate, at least one of the following components:
e from 0.1 to 20% by weight, based on the total weight of components A, B, C, and D, of a dispersing agent component E, and also
f from 0.1 to 40% by weight, based on the total weight of components A, B, C, and D, of an additive F.

42. The dispersion according to claim 41, wherein the component C used comprises metal powder.

43. A process for the production of a dispersion according to claim 41, comprising the steps of:
a) mixing of components A to C, and at least a portion of component D, and also, if appropriate, of E, and F, and of further components, and
b) dispersion of the mixture.

44. A process for the production of a metal layer on at least a portion of the surface of a non-electrically-conductive substrate, comprising the steps of:
a) at least partial application of a dispersion according to claim 41 to the substrate;
b) at least partial drying and/or partial hardening of the applied dispersion layer on the substrate; and
c) deposition of a metal by a currentless and/or electroplating method on the at least partially dried and/or at least partially hardened dispersion layer, forming a metal layer, where if appropriate, between steps b) and c), a surface of the at least partially dried and/or hardened dispersion layer is activated.

45. A substrate surface, at least partially having an electrically conductive metal layer obtainable from the process according to claim 44.
